(19) United States
(12) Patent Application Publication
(10) Pub. No.: US 2026/0368349 A1
(43) Pub. Date: Nov. 19, 2026

(54) METHODS AND SYSTEMS FOR IMPLEMENTING A CONTEXTUAL KNOWLEDGE RETRIEVAL SYSTEM FOR SERVICES

(71) Applicant: HUBSPOT, INC., Cambridge, MA (US)

(72) Inventors: Blake Andrew WILLS, Durham, NC (US); Robert Davis MASTIN, Nashville, TN (US); Mahesh Kumar SAMPEKATTE SEENAPPA, North Andover, MA (US); Thomas Carrier LUCY, Boston, MA (US)

(21) Appl. No.: 19/575,213

(22) Filed: Mar. 23, 2026

Related U.S. Application Data
(60) Provisional application No. 63/808,128, filed on May 19, 2025.

(51) Int. Cl. G06F 21/62; G06F 16/2457

(52) U.S. Cl. CPC G06F 21/6227; G06F 16/24575

(57) ABSTRACT

Systems and methods are provided for implementing a contextual knowledge retrieval system for services. A knowledge box is created to organize contextual data provided by knowledge sources paired with the knowledge box. A service may be identified as being assigned a computer implemented task to perform using a model to process a prompt. A knowledge box is searched to identify select contextual data relevant to the computer implemented task. The prompt may be augmented with the select contextual data for processing by the model to generate an output for the prompt. In this way, the computer implemented task is performed based upon the output from the model.

### CROSS-REFERENCE TO RELATED APPLICATIONS

This application claims priority to U.S. Provisional Patent Application, titled “METHODS AND SYSTEMS FOR IMPLEMENTING A CONTEXTUAL KNOWLEDGE RETRIEVAL SYSTEM FOR SERVICES”, filed on May 19th, 2025 and accorded Application No.: 63/808,128, which is incorporated herein by reference for all purposes.

### BACKGROUND

A platform, such as a multi-service business platform, may host services that provide users with various functionality. For example, an email service may provide users with email composition functionality such that the service may generate template emails for the user. A blog service may provide users with blog creation functionality such that the blog service may generate template blogs for the user. A customer relationship management (CRM) service may store information within objects of a CRM database on behalf of users, such as an email object to represent an email received by a user, a contact object to represent a sender of the email, a deal object to represent a deal being negotiated between the user and the sender, etc. In this way, the platform hosts services that provide a variety of different functionality to users.

### DESCRIPTION OF THE DRAWINGS

Embodiments of the present technology will be described and explained through the use of the accompanying drawings in which:

FIG. 1 is a block diagram illustrating an embodiment of a system for implementing a contextual knowledge retrieval system for services, in accordance with an embodiment of the present technology.

FIG. 2 is a flow chart illustrating an embodiment of a method for implementing a contextual knowledge retrieval system for services, in accordance with an embodiment of the present technology.

FIG. 3A-3D are block diagrams illustrating an embodiment of a system for implementing a contextual knowledge retrieval system for services, in accordance with an embodiment of the present technology.

FIG. 4 is a block diagram illustrating a management interface, in accordance with an embodiment of the present technology.

FIG. 5 is an example of a computer readable medium in which an embodiment of the present technology may be implemented.

FIG. 6 illustrates an exemplary computing environment wherein one or more of the provisions set forth herein may be implemented.

FIG. 7 illustrates an exemplary multi-service business platform wherein one or more of the provisions set forth herein may be implemented.

The drawings have not necessarily been drawn to scale. Similarly, some components and/ or operations may be separated into different blocks or combined into a single block for the purposes of discussion of some embodiments of the present technology. Moreover, while the present technology is amenable to various modifications and alternative forms, specific embodiments have been shown by way of example in the drawings and are described in detail below. The intention, however, is not to limit the present technology to the particular embodiments described. On the contrary, the present technology is intended to cover all modifications, equivalents, and alternatives falling within the scope of the present technology as defined by the appended claims.

### DETAILED DESCRIPTION

Systems and methods are provided for implementing a contextual knowledge retrieval system for services. The contextual knowledge retrieval system includes a centralized contextual layer that enhances the performance of services across a platform, such as a multi-service business platform that provides content management, payment processing functionality, workflow automation, reporting, analytics, a customer relationship management (CRM) system, a content management system (CMS), conversation intelligence, etc. In some embodiments, the contextual knowledge retrieval system may be implemented as Knowledge as a Service that provides contextual data to the services of the platform so that the services can operate more efficiently and with higher accuracy.

Without the additional contextual data provided by the centralized contextual layer to the services, these services may generate outputs that are over generalized, generic, or inappropriate responses with little to no relevancy to the task being performed by the services. For example, an email generation service may implement a model that is trained on emails relating to various topics so that the model can be used by the email generation service to automatically generate emails for users. When a user invokes the email generation service to generate an email, the generated email may be generic and/or unhelpful if the generated email is not tailored to the specific context of what the user is attempting to accomplish with the email. For example, the user may want to write a technical email to a customer about how to troubleshoot an application error. However, the generated email may provide generic information such as a general phone number to customer service, a suggestion to submit a service ticket, and/or a suggestion to try a chat bot. However, the customer may have already created a service ticket that the user is currently troubleshooting on behalf of the customer. Thus, the generated email would be unhelpful, and the user would have to re-write the email from scratch. In addition to creating overgeneralized outputs that cause services to generate responses that lack personalization, the model may hallucinate and generate an inappropriate response that has no relevancy to the initial request or task given to the service.

Accordingly, as provided herein, the disclosed contextual knowledge retrieval system improves the technical operation of services by implementing Knowledge as a Service for the services. In particular, the disclosed contextual knowledge retrieval system embeds a centralized contextual layer into the services to provide models or other functionality with additional context for processing read and write queries/requests. The contextual knowledge retrieval system provides unified knowledge integration by combining various data sources that may be internal or external to the platform into a single system, such as from data sources that include voice transcripts, service tickets (e.g., a customer service ticket to troubleshoot an issue for a customer), CRM objects, website data, news, social media posts, emails, user interaction with services, personalized user information and activities, user uploaded documents, and/or other content.

The contextual knowledge retrieval system manages a dynamic skills library that provides services with the ability to access skills (e.g., skills for generating programming code, creating an email, writing a blog, processing data, performing machine learning functions, engaging in a conversation such as by a chat bot, or other skills/tools to perform tasks and solve problems). The contextual knowledge retrieval system provides the ability to update skills based on the latest knowledge/contextual data ingested from the data sources. The contextual data is organized and stored into knowledge boxes maintained by the centralized contextual layer of the contextual knowledge retrieval system. The contextual knowledge retrieval system structures and reformats structured data and unstructured data retrieved from the data sources into a format that is highly efficient and interpretable by models such as large language models to enhance comprehension and response accuracy of services leveraging the models. In this way, the performance of the services is enhanced by improving the contextual understanding of tasks and how to perform tasks, thus leading to more accurate and relevant responses of task execution results. The contextual knowledge retrieval system provides users with a management interface and tools to manage and customize their knowledge environment effectively, such as by providing fine grained insight and control over how contextual data is being stored into knowledge boxes and is being provided to services.

In some embodiments, the contextual knowledge retrieval system implements a security and access control layer for the centralized contextual layer. The security and access control layer is implemented as an arbiter of which services have access to which knowledge sources from which contextual data is extracted and organized into knowledge boxes. The security and access control layer may implement role or user based access control as a security layer for the knowledge sources. In some embodiments, the security and access control layer implements a model context protocol (MCP) used to define how services/layers/platforms provide contextual data to models for generating outputs used by the services to perform tasks. The MCP may be used to create a secure two-way connection between the services/models and the data sources such as a CRM database, an emails repository, websites, transcripts, logs of user interactions with services, social media posts, workflow execution logs, etc.

Based on a type or specificity of a question/request asked of a service (e.g., a specific question compared to an open ended question) and/or how structured is corresponding contextual data (e.g., a structured CRM object with properties stored in rows and columns compared to an unstructured blog of data), the contextual data may be formatted into a format optimized for processing by a model. Thus, the model will output a more precise and accurate output so that the service can more effectively and efficiently perform the task. The contextual knowledge retrieval system improves resource utilization by optimizing the contextual data provided to the services. A service can now provide a high quality response/output for a task because the service is given a determined amount of contextual data that will result in a more precise and accurate output than if more or less contextual data was provided to the service. That is, a model may hallucinate or output worse answers if there is too much noisy data being input into the model, and the model may output generic, non-personalized, and/or irrelevant answers if the model does not have enough context. In this way, services are provided with a specific amount of contextual data that will result in fewer compute resources to efficiently run models to generate accurate outputs such as high quality and personalized responses without wasting compute resources on processing too much contextual data that could result in hallucinations and poor responses from the models.

The contextual knowledge retrieval system improves upon conventional data storage and data input into models by reducing the cost of searching for relevant contextual data used by models to generate outputs for services. In particular, data sources such as CRM databases, websites, logs of user interaction data, emails, and/or a variety of other internal or external content sources may be represented and managed using knowledge sources that are assigned to knowledge boxes. The knowledge boxes are used to logically organize and manage the contextual data. In particular, conventional systems may utilize a retrieval-augmented generation (RAG) system where data can be retrieved through search and augmentation. The RAG system stores a significant amount of data in vector storage (a vector database of embeddings), such as for embeddings (contextual chunking). A conventional search of the RAG system will search the entire vector storage, which consumes a large amount of resources and is inefficient. Instead, contextual data is organized and grouped into different knowledge boxes so that merely a particular knowledge box or subset of a knowledge box is searched. Accordingly, an optimal or efficient contextual chunking is determined based upon a given contextual use case such as a particular task a service is attempting to perform. The contextual chunking may be associated with a knowledge box. The knowledge box is an organization unit for embeddings that are ingested into the RAG system for storage. Thus, searching merely the knowledge box or subset of the knowledge box based upon the contextual chunking will reduce the search space because merely a subset of the entire vector storage such as the knowledge box is searched. Narrowing the search window greatly reduces the time and resources used to search the RAG system for relevant contextual data to provide to a service.

In some embodiments, the search is more efficient and selective based upon the organization of contextual units by tagging the contextual units based upon search themes and queries so that the search is more optimized. Also, search windows are constrained to a knowledge box granularity of knowledge boxes that are allowed to be accessed by a requesting service. Instead of each service using its own database for storing contextual data, a knowledge box is implemented as a reusable storage/contextual unit that can be shared by different services. Thus, contextual data is shared amongst services, and the centralized contextual layer and/or security and access control layer are arbiters of which services can access which knowledge boxes. Models, used by certain services, are constrained to behave in a certain way because only contextual data in certain knowledge boxes are made available to a model, while contextual data of other knowledge boxes is restricted from being accessed by the model so that the model does not hallucinate or behave in an unintended manner. In this way, the contextual knowledge retrieval system improves the efficiency and operation of services by selectively providing a service with a certain amount of select contextual data in a secure manner so that a model, used by the service to perform a task, can output an accurate and relevant task result in a resource efficient manner.

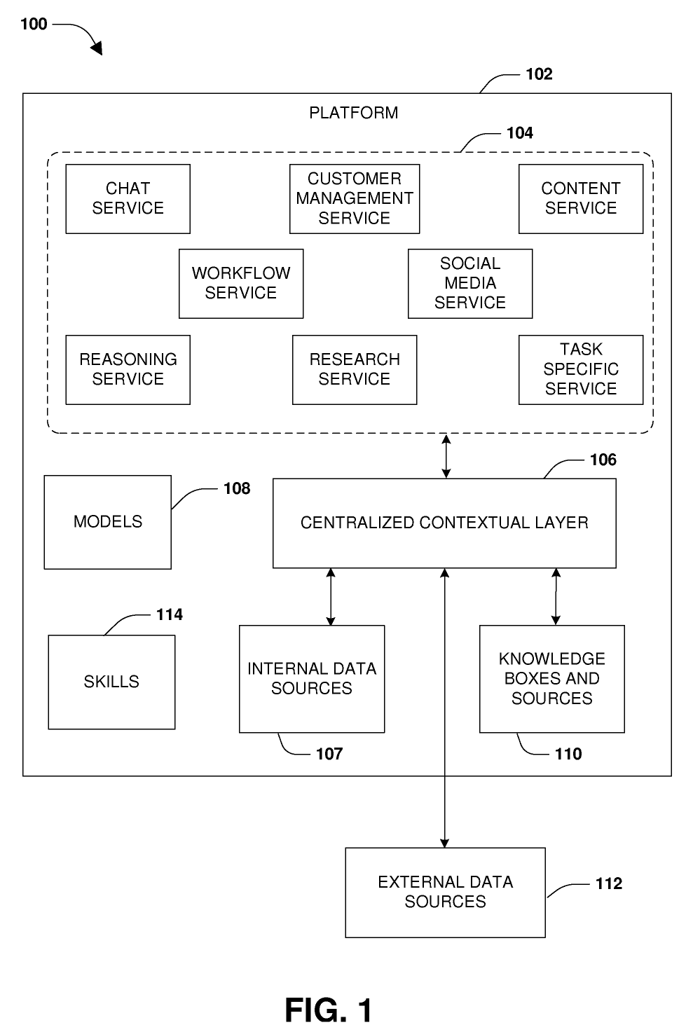

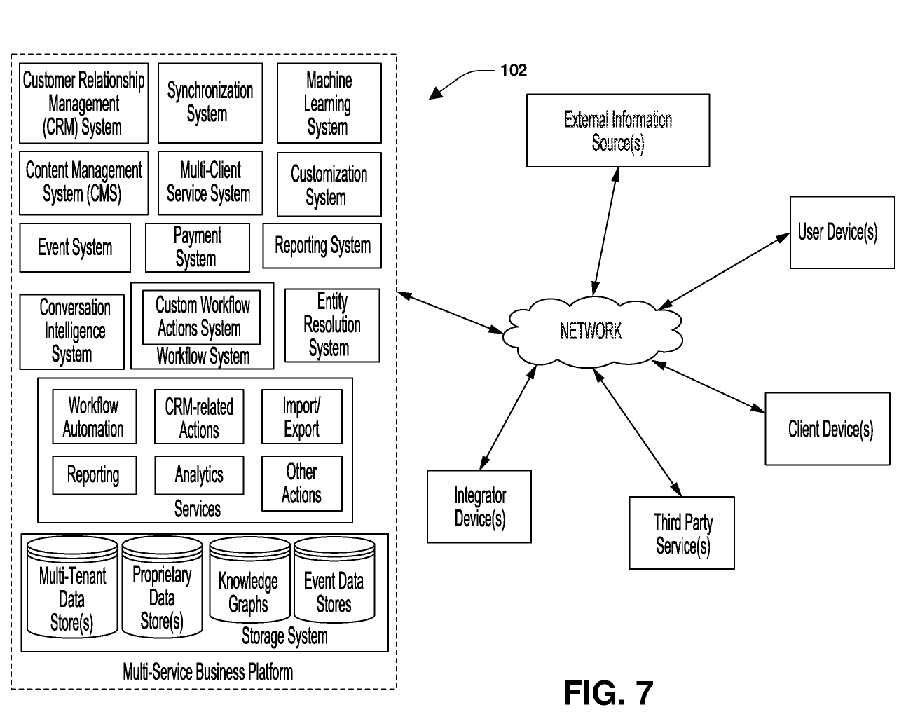

FIG. 1 is a block diagram illustrating an embodiment of a system 100 for implementing a contextual knowledge retrieval system for services. The system 100 may include or may be associated with a platform 102, such as the multi-service business platform illustrated by FIG. 7. It may be appreciated that additional details of the multi-service business platform will be subsequently described in relation to FIG. 7. For example, the contextual knowledge retrieval system may provide contextual information to the systems and services illustrated by FIG. 7. In some embodiments, the platform 102 may include services 104, such as a chat service that hosts a chat bot, a customer management service used to track customers and customer interactions, a content service used to generate content such as email or blogs, a workflow service used to execute computer implemented workflows such as sending a follow-up email or creating a service ticket, a social media service, a reasoning service that provides advice and logical reasoning/solutions to requests submitted to the reasoning service, a research service that provides answers and information in response to questions asked of the research service, a task specific service that performs specific computer implemented tasks, etc.

The services 104 may utilize models 108 for performing computer implemented tasks. The models 108 may include machine learning models such as large language models, generative models, or any other type of model that takes an input such as a prompt and generates an output. The models 108 may be pre-trained on various training datasets. However, the models 108 may be trained on general datasets that are not specific to the services 104 of the platform 102, and thus the models 108 may generate generic and non-personalized outputs that are used by the services 104 to perform computer implemented tasks such as to generate an email, write a blog, answer a question, generate a video, engage in a conversation with a user, prep a user for a meeting, etc. The contextual knowledge retrieval system implements a centralized contextual layer 106 that improves the quality and relevancy of outputs by the models 108 (e.g., reduced hallucinations and more relevant and personalized outputs based upon contextual data). The centralized contextual layer 106 is implemented to improve the operational efficiency of the models 108 and services 104 (e.g., more efficient resource utilization by processing an appropriate and determined amount of contextual data, a more efficient and quicker search for contextual data, etc.).

The centralized contextual layer 106 is configured to selectively provide a certain amount of contextual data to a service for input into a model that generates an output used by the service to perform a computer implemented task. For example, a user may ask the service to generate an email for a potential client, and the service may utilize a large language model to output text used to generate the email. Without contextual information, the model may output generic email content because the model may have been pre-trained on a general set of emails that are not specific to the user, the potential client, a business of the user, past interactions between the user and the potential client, etc. Accordingly, the centralized contextual layer 106 searches knowledge boxes 110 within which contextual data from internal data sources 107 of the platform (e.g., emails, call transcripts, CRM objects, contacts, service tickets such as help desk tickets, workflow execution, etc.) and/or external data sources 112 are organized. In particular, a knowledge box may include one or more knowledge sources that extract information from the data sources. In this way the centralized contextual layer 106 may search a specific knowledge box(es) for which the service has permission to access to obtain relevant contextual information, such as information related to the user, the potential client, a business of the user, past interactions between the user and potential client, etc.

The contextual information (e.g., information extracted from a customer CRM object representing information about the potential customer, emails of past interactions and communications with the potential customer, information extracted from a website of the potential customer, information about the user such as a position held by the user with the company, social media posts by the potential customer, etc.) may be used to augment a prompt for input into the model for generating an output used to create the email. Additionally, output by skills 114 (e.g., tools such as an email generation tool or an image generation tool used to create an image to include within the email) may additionally be augmented with contextual information by the centralized contextual layer 106. In this way, the service is capable of creating an email that is personalized and contextually relevant to the user and the potential customer. For example, the email may take into account details related to past interactions between the user and potential customer, information about the potential customer, and/or information about the user.

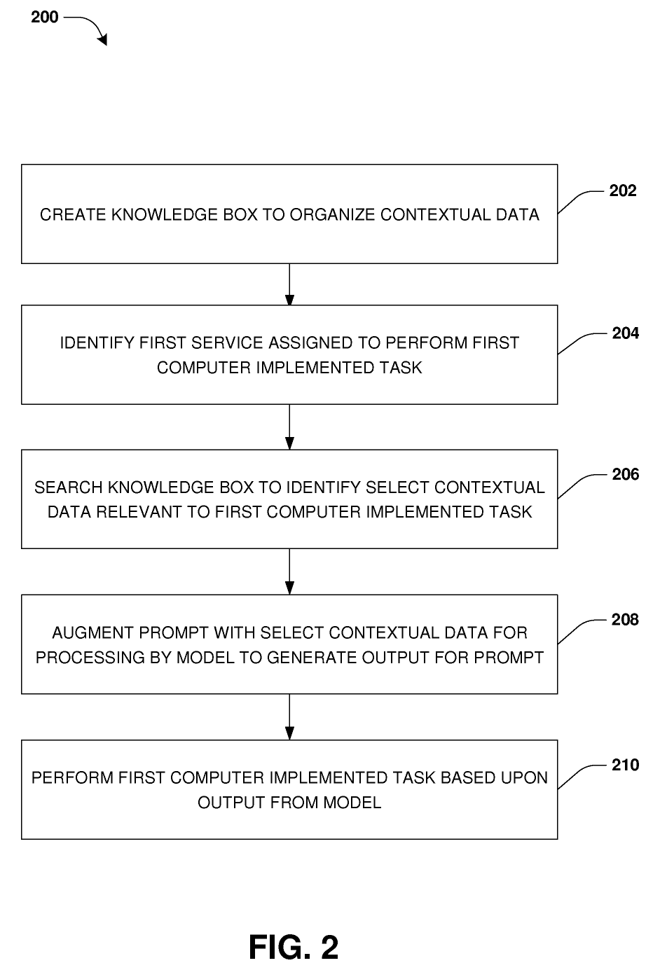

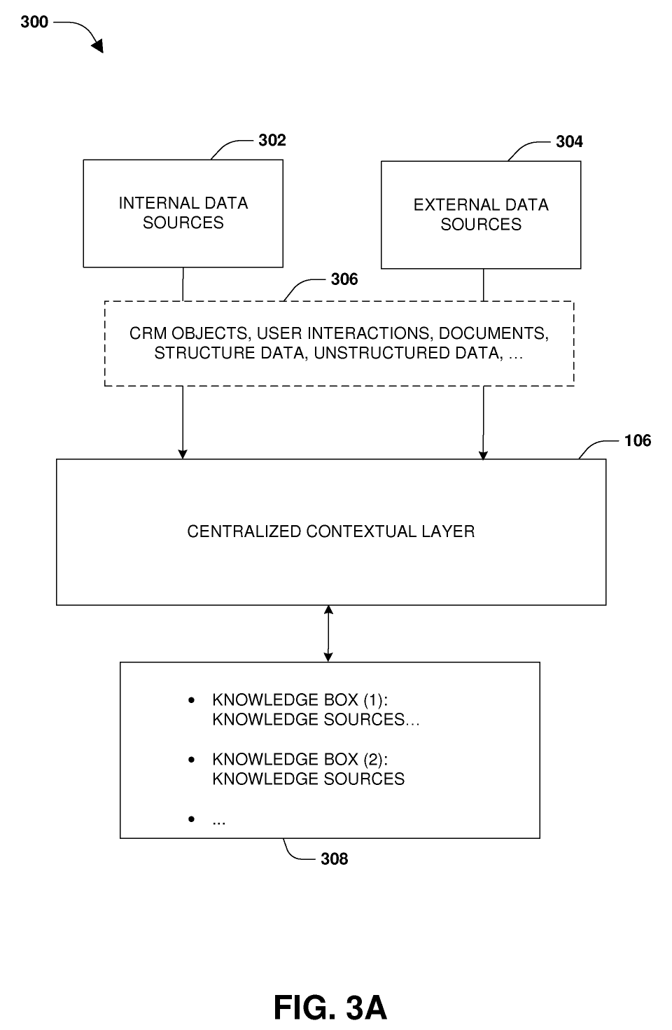

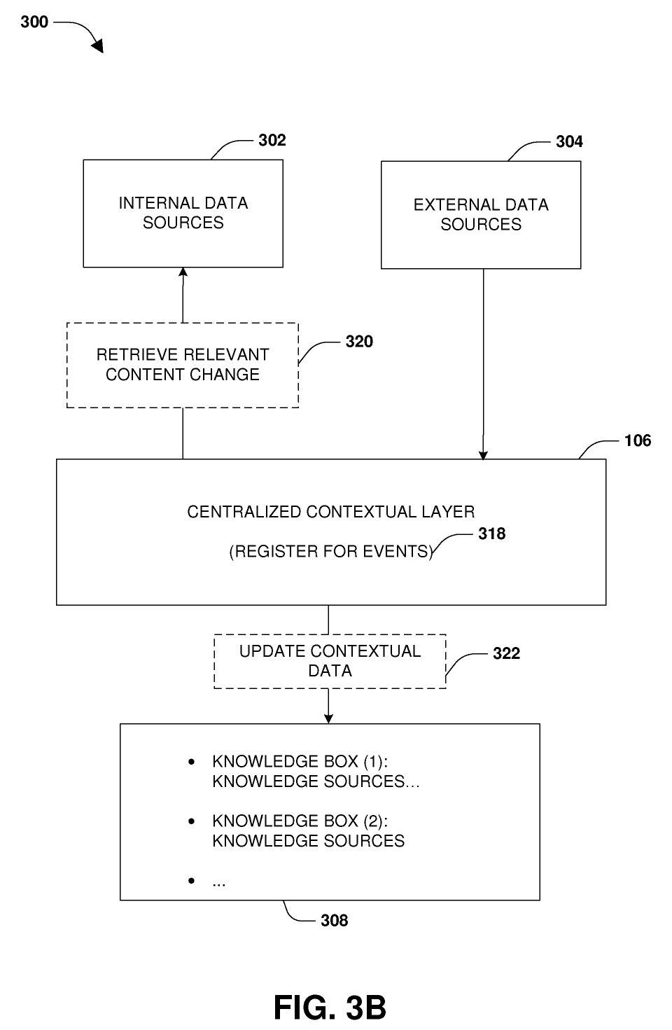

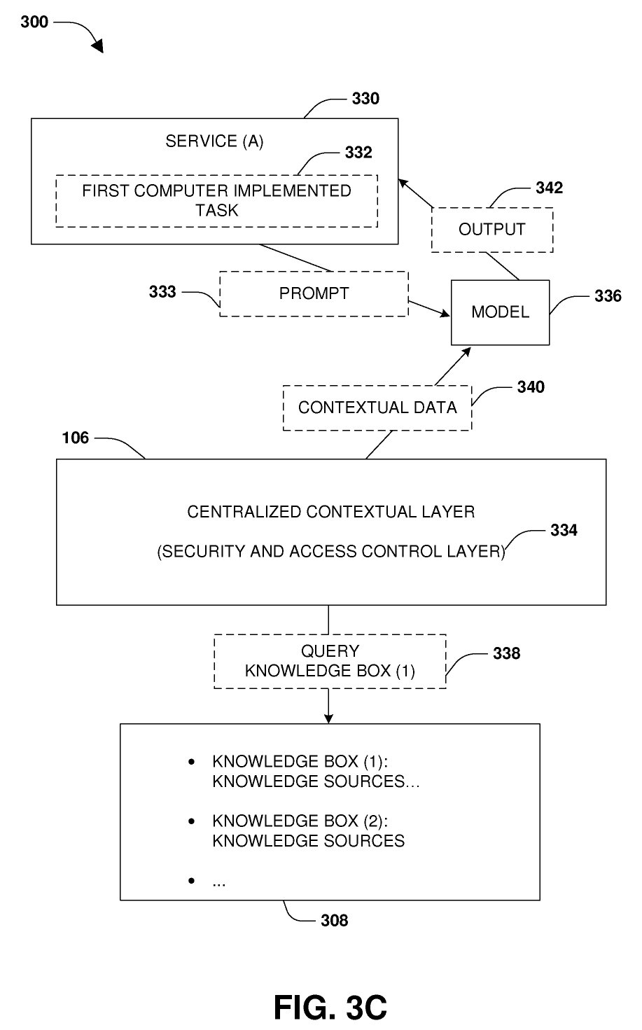

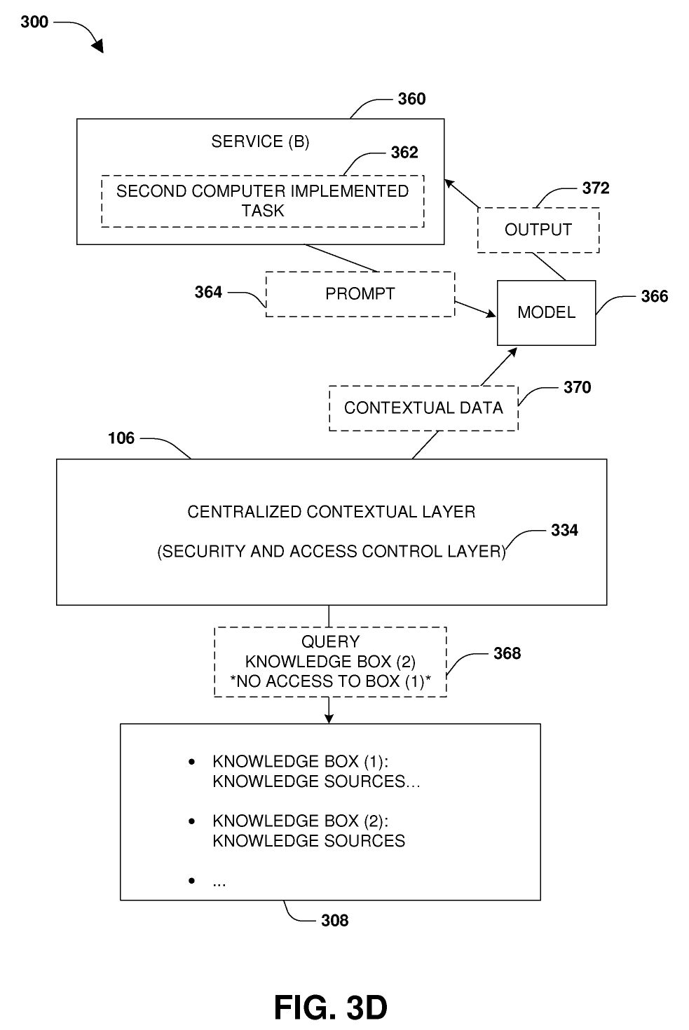

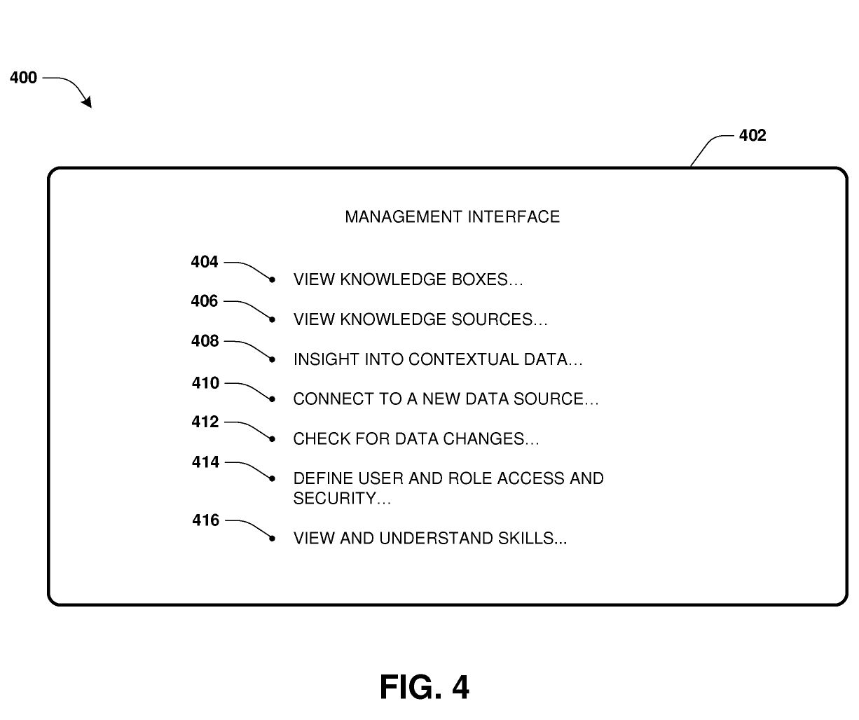

FIG. 2 is a flow chart illustrating an embodiment of a method 200 for implementing a contextual knowledge retrieval system for services, which is described in conjunction with system 300 of FIGS. 3A – 3D and management interface 400 of FIG. 4. The centralized contextual layer 106 may identify/discover data sources from which contextual information can be retrieved 320. The data sources may include internal data sources 302 of the platform 102, such as objects within a CRM database, logs of user activity and interactions with services (e.g., services and systems of the multi-service business platform, illustrated by FIG. 7), stored transcripts of conversations, emails, calendar entries, files, uploaded documents, a cloud storage drive, etc. The data sources may include external data sources 304 such as websites, news articles, social media posts, blogs, or other information available from sources external to the platform 102.

In some embodiments, the centralized contextual layer 106 defines knowledge boxes 308 for storing and organizing contextual data of knowledge sources corresponding to the data sources from which the contextual data is retrieved 306. A knowledge source may be defined for a particular data source, and may store various information such as how to access the data source, what information has been extracted from the data source, a last time the information was extracted from the data source, whether the data source is to be monitored, such as through events, for data changes to retrieve for updating the knowledge boxes 308, etc. The knowledge source may be defined to include a CRM object, a transcript, an online storage device, a document such as a document uploaded by a user, user information (e.g., a role of a user at a company, a social media post by the user, a blog by the user, services accessed by the user, interactions by the users with others such as emails, calendar entries, location information, etc.), user interaction with the platform 102 (e.g., a transcript of an AI/ML concierge service providing the user with information to prepare the user for a work meeting), user interaction with an AI agent, emails, websites, structured data (e.g., data stored within a database table), or unstructured data (e.g., a blog of data).

One or more knowledge sources may be assigned to a knowledge box that is defined to organize and scope contextual data from the one or more knowledge sources. The knowledge box may be defined as a shared and reusable knowledge box made accessible from the centralized contextual layer 106 to a plurality of services for reusable retrieval of contextual data. In some embodiments, the contextual data of the knowledge boxes is physically stored within a vector database of a retrieval-augmented generation platform. The contextual data may be organized/grouped into organizational contextual units (e.g., information extracted from an email, information extracted from a paragraph of a blog, information extracted from a particular section of an article, information extracted from a certain CRM object, etc.). The organizational contextual units may be tagged based upon search themes and queries used to obtain contextual information organized into the organizational contextual units. The organizational contextual units may be tagged for quick and efficiently search for contextual information to provide to a service (e.g., an organizational contextual unit may be tagged with “email between Dan and potential customer Sarah”). In this way, the centralized contextual layer 106 retrieves contextual data 306 from the data sources, and organizes the contextual data as organizational contextual units into knowledge boxes 308, as illustrated by FIG. 3A.

In some embodiments, knowledge sources encompass any structured or unstructured data asset, such as a CRM object, a transcript (e.g., a voice recording transcript of a phone call), a knowledge base article, external system data, or multimedia file. Contextual data is ingested from the knowledge sources, and is organized into structures, referred to as knowledge boxes. The knowledge boxes (structures) are configured as a highest organizational level for the contextual data. Knowledge source groups may be created to bundle data that shares common external attributes. For example, web pages under a signal domain name may be bundled/grouped together into the same knowledge source group. In another example, files within a specific folder may be bundled/grouped together into the same knowledge source group. A knowledge box may contain both dynamically updated knowledge source groups (e.g., newly added or updated contextual data of a knowledge source group is used to dynamically update the knowledge box) and/or individual data sources. This hierarchical structure of knowledge boxes, knowledge sources, knowledge source groups, and contextual data allows the disclosed methods and systems to backlink individual data points to their origins (e.g., a file within a particular folder, a web page from a particular domain, workflow information within a workflow CRM object, a transaction described in a transcript, a troubleshooting step from a knowledge base article, a computer issue to resolve from a helpdesk ticket CRM object, or other contextual data from a particular knowledge source, structured data asset, and/or unstructured data asset). This backlink information between data points and origins of the data points may be used to provide highly filtered and efficient search for context

In some embodiments, a designation of one or more content items to upload into the knowledge boxes 308 may be received by the centralized contextual layer 106 through an interface. For example, a user may utilize the interface to select documents such as pdf documents to upload as content items from which contextual information can be extracted and organized into the knowledge boxes 308 for storage within a vector database or other type of storage. The centralized contextual layer 106 ingests the content items into the knowledge box, and implements a contextual chunking strategy for the content items to create contextual chunks of organizational contextual units for storage within the knowledge boxes 308. The contextual chunks may be ranked based upon how contextually relevant the contextual chunks may be for a given prompt/task being processed by a service (e.g., cosine similarity between vector embeddings of a prompt and contextual chucks may be determined to identify the most similar contextual hunks in relation to the prompt). According, a contextual chunk of contextual data may be selected for input into a model used by the service to process the prompt to perform the task (e.g., a highest ranked / most relevant contextual data in relation to the prompt and/or task).

Contextual data can change over time, such as where new information is populated into a CRM object, a company moves to a new location, a website is updated to remove a discontinued product, a user leaves a company, a new email is created, a blog is updated with new content, etc. Accordingly, the centralized contextual layer 106 may registered/subscribe 318 to events corresponding to context changes for content items from which contextual data is extracted, as illustrated by FIG. 3B. For example, an event may correspond to a workflow being executed, an email being received, a website being updated, a social network post being created, a transcript being created, information within a CRM object being changed such as to indicate a new location of a company, etc. In response to an event occurring such as information within a deal CRM object being updated with new details of a deal being negotiated with a customer, relevant content changes are retrieved 320 from the corresponding data source. The relevant content changes are used to update 322 the contextual data within the knowledge boxes 308. If the relevant context change is relevant to a computer implemented task being performed by a service, then contextual data being provided to the service may be updated with the relevant context change before being provided to the service.

As part of executing the method 200, a knowledge box may be created to organize contextual data provided by knowledge sources paired with the knowledge box, during operation 202 of method 200. A security and access control layer 334 for the centralized contextual layer 106 may specify which services are allowed to access which knowledge boxes organizing contextual data of the knowledge sources, as illustrated by FIG. 3C. The security and access control layer 334 may implement user and/or role based access control, such as where the service is allowed to access a first knowledge box based upon credentials of the user and/or a role of the user. The security and access control layer 334 may block the service from accessing contextual data in other knowledge boxes such as a second knowledge box.

During operation 204 of method 200, a service (A) 330 may be identified as being assigned a first computer implemented task 332 to perform using a model 336 to process a prompt 333 (e.g., a user may request the creation of a blog about running with images of the latest running shoes and a list of upcoming marathons), as illustrated by FIG. 3C. In response to the security and access control layer 334 determining that the service (A) 330 has permission to access the first knowledge box, the centralized contextual layer 106 executes a query 338 to search the first knowledge box to identify and retrieve a select amount of contextual data as select contextual data 340 relevant to the first computer implemented task 332, during operation 206 of method 200. In some embodiments, the amount of contextual data is determined based upon a relevancy selection criteria for chunk filtering and selection. That is, a chunking strategy is used to chunk contextual data into contextual chunks of organizational contextual unit that could be individually searched and retrieved. The relevancy selection criteria may be defined based upon an upper threshold of contextual data such that an amount of contextual data exceeding the upper threshold would result in the model 336 hallucinating from having too much information to process and the service (A) 330 wasting time and resources from processing more information that necessary. The relevancy selection criteria may be defined based upon a lower threshold of contextual data such that an amount of contextual data less than the lower threshold would result in the model 336 not have enough contextual information to provide relevant and/or personalized outputs for performing the first computer implemented task 332 (e.g., the blog may be too generic without any relevant context to the user/author, to an audience of the blog, etc.).

In some embodiments, the platform 102 implements search functionality through the method 200. The method 200 extends the search functionality beyond conventional text searching to include visual data, audio data, and/or video data not currently supported by conventional platforms. Conventional search techniques utilize separate vector indexes per modality (e.g., a text vector index for text) or rely on limited multimodal embedding models with distinctive limitations, such as high computation costs, difficulty in capturing complex relationships between different data types, an inability to align disparate data types (e.g., text is discrete tokens, while images and audio are continuous pixels/waveforms with distinct statically properties that are difficult to align), high inference latency (e.g., most devices lack adequate compute resources for real-time processing of video, audio, and/or text), storage overhead (e.g., high-dimensional, multi-vector representations can significantly increase the size of vector indexes such as 1,000 times more than text-only), information asymmetry with unbalanced embeddings (e.g., a single word may represent a concept that would be represented by thousands of pixels, such as the word “dog” compared to an image of a dog), etc. The disclosed search functionality overcomes these technical challenges and limitations and improves upon conventional search techniques by utilizing a custom created LLM to describe non-text modalities as representations (e.g., converting visual data, audio data, and/or video data into text representations) that are stored alongside standard text (e.g., text representations of text data) in a unified index. The unified index (e.g., an index of representations for text, visual data, audio data, video data, etc.) provides a unified approach that allows for combined searching of different modalities of contextual data. The searching functionality is able to seamlessly link the text representations of the non-text modalities back to the original non-text assets during search and retrieval (e.g., a text representation of an image may be linked back to the original image).

In some embodiments of performing contextual chunking and retrieval as part of chunk filtering and selection, the contextual chunking includes adjusting the size and boundaries of data chunks (e.g., splitting on sentence boundaries verse splitting on JSON object boundaries for different chunks of contextual data). The size and boundaries are adjusted based upon the specific shape of source data (contextual data). The data chunks, with the adjusted sizes and boundaries, are embedded to create points within a single, optimized vector space. The points within the vector space are used during a search as part of determining relevancy using embedding models and a re-ranking model. An additional relevancy layer automatically pulls in associated data sources based on known relationships within the platform 102, which is used by the relevancy layer to evaluate the points within the vector space for identifying data chunks, from the data sources, that are relevant to a current search.

In some embodiments of retrieving the select contextual data 340, a semantic search is performed over a vector store (a vector database) of a retrieval-augmented generation platform by using application programming interface (API) lookups to identify the select contextual data 340. For example, the prompt 333 may be used to perform the semantic search such as where an embedding (a vector embedding) is created from the prompt 333, and is used to search the first knowledge box for embeddings of contextual data that are semantically similar to the embedding of the prompt 333. For example, contextual data related to running, running shoes, marathons, athletic wear companies, etc. may be identified as being relevant for creating the blog.

In some embodiments of retrieving the select contextual data 340, a contextual chunking strategy is selected based upon a contextual use case of the first computer implemented task 332, such as a contextual use case to obtain information for writing a blog with text and images. An organizational contextual unit of the first knowledge box may be searched based upon the prompt 333 and the query 338 derived from the contextual chunking strategy for identifying the select contextual data 340. The search may be constrained to a subset of the vector database corresponding to the organizational contextual unit, which makes the search faster and more efficient compared to searching the entire vector database.

In some embodiments of retrieving the select contextual data 340, first contextual data is selected as the select contextual data 340 based upon the first computer implemented task 332 relating to a read workflow (e.g., reading information to provide to the user). Second contextual data is selected as the select contextual data 340 based upon the first computer implemented task 332 relating to a write workflow (e.g., generating content such as the blog or a CRM object as the task). Thus, certain contextual data may be selected based upon the type of task.

In some embodiments of retrieving the select contextual data 340, a structure type of available contextual data within the first knowledge box may be determined, such as highly structured data stored within database tables or an unstructured blob of data. A specificity type of the query 338 or prompt 333 may be determined, such as where the prompt 333 is an non-specific question or instruction (e.g., “what should I do today) or a highly specific question (e.g., “what is the best price of this running shoe”). A contextual content source may be selected for obtaining the select contextual data 340 based upon the structure type and the specificity type. The contextual content sources may include a retrieval-augmented generation platform (e.g., selected based upon more query flexibility and more object structure flexibility), an API endpoint (e.g., selected based upon less query flexibility and less object structure flexibility), a natural language processing API endpoint (e.g., selected based upon more query flexibility and less object structure flexibility), or a structured tag library (e.g., selected based upon less query flexibility and more object structure flexibility).

During operation 208 of method 200, the prompt 333 is augmented with the select contextual data 340 for processing by the model 336 to generate an output 342 for the prompt 333. For example, the output 342 may include text and/or images that can be used by the service (A) 330 to perform the first computer implemented task 332 for creating the blog. In some embodiments, the select contextual data 340 is formatting from a native format (e.g., a CRM object format, HTML of a website, etc.) into a format tailored for prompt injection into the model 336. The formatting may include summarization of the select contextual data 340, a JSON to natural language flattening, and/or chunk prioritization. In some embodiments, the select contextual data 340 is formatted based upon a type of question of the prompt 364 and/or an amount of structure of the select contextual data 340 (e.g., is the select contextual data 340 highly structured such as within a database table, or an unstructured blob of data) to create formatted contextual data that is input into the model 336.

In some embodiments of formatting contextual data into a format tailored for models such as LLMs, data is initially structured and vectorized into a format that is optimized for semantic search retrieval (e.g., a search for “how to quiet my phone” may be input into a model that performs a semantic search that returns a document titled “Muting notifications and changing volume on phone model XYZ,” where “quiet” is semantically related to “muting notifications” and “changing volume”). Before the retrieved data (contextual data) is input into an LLM, the retrieved data is reformatted into an LLM-optimized structure by a reformatting process. The reformatting process utilizes XML-based structures and/or JSON flattening to reduce complexity of the data. The reformatting process actively minimizes token usage to reduce processing, resource consumption (compute and memory), cost, and energy consumed by the LLM, thus making the LLM more efficient and improving the operation of the LLM, the platform 102, and the method 200. The token usage is minimized by filtering results based on modality (e.g., filtering the contextual data based on different formats of data types, such as text, images, audio, video, time series data, etc.). For example, the reformatting process strictly limits the number of images eligible to be passed to the model, and filters/removes any addition images beyond the limit. Intelligent filtering reduces the amount of data being input into the LLM for processing, thus improving the efficiency of the LLM and reducing the compute, memory, and energy resources consumed by the LLM. Retrieved chunks of contextual data are hydrated with citations and/or necessary metadata by the reformatting process so that the LLM does not have to expend compute resources attempting to reason about an origin of the data. In some embodiments, the reformatting process may be incorporated into the LLM as a technical improvement over conventional and routine LLMs by modifying the native operation of the LLM with input filtering functionality. With the technical advances and expansion of AI, machine learning models (LLMs), and data centers, reducing the processing and resource usage by the models and improving the efficiency of the models is a significant technical improvement, especially with the amount of electricity consumed by data centers becoming a technical real world problem.

In some embodiments, a set of skills available for the service (A) 330 to use for performing the first computer implemented task 332 may be identified. An explanation of the set of skills may be provided to the service (A) 330 so that the service (A) 330 can utilize the skills such as tools used to generate content or perform subtasks for the first computer implemented task 332. In response to the service (A) 330 invoking a skill, the centralized contextual layer 106 may provide additional context for information returned by the skill. The additional context may be determined from the contextual data within the first knowledge box.

In some embodiments, an agent orchestrator of the contextual knowledge retrieval system may receive the prompt 333. The agent orchestrator may create and queue a job for processing the prompt 333. An orchestrator worker of the contextual knowledge retrieval system may process the job by selecting an agent definition corresponding to a select model, such as model 336, for solving the first computer implemented task 332 specified by the job. The orchestrator worker may search a skill library for a skill relevant to the first computer implemented task 332 based upon a knowledge map specifying skills available for the orchestrator work for solving/performing the first computer implemented task 332. The service (A) 330 may be provided with access to the skill. The orchestrator worker may augment a skill output from the skill with additional context obtained from the first knowledge box to create an augmented skill output. In this way, the first computer implemented task 332 is performed based upon the output from the model 336 and/or the augmented skill output, during operation 210 of method 200.

FIG. 3D illustrates the centralized contextual layer 106 querying 368 a second knowledge box for select contextual data 370. The select contextual data 370 is used to augment a prompt 364 associated with a service (B) 360 performing a second computer implemented task 362 based upon the security and access control layer 334 determining that the service (B) 360 has access to the second but not the first knowledge box. The augmented prompt is input into the model 366 that generates an output 372 used by the service (B) 360 to perform the second computer implemented task 362.

The centralized contextual layer 106 may be trained based upon detected user corrections to the output 372 and/or results of tasks being performed by services using the contextual data. The centralized contextual layer 106 may be trained on how to select certain contextual data, how to organize the contextual data into organizational contextual unit and knowledge boxes, and how much contextual data to select.

In some embodiments, the contextual knowledge retrieval system provides a management interface 402 through which users can view knowledge boxes 404, view knowledge sources 406, view insight into contextual data 408, connect to a new data source 410, check for data changes 412, define user and roll access and security 414, and/or view and understand skills 416. In this way, the management interface 402 may be populated with contextual data upload functionality, data source connection functionality, and a visualization of contextual data and an internal interpretation of the contextual data for user understanding and managing the contextual data.

The disclosed techniques may be implemented to control custom assistants such as a frequently asked questions (FAQ) assistant or a work assistant. The custom assistants support tasks ranging from information retrieval to content generation and decision making (e.g., generating troubleshooting instructions for troubleshooting/resolving a problem such as a computer or service failure; determining whether to send an email to a user; determining whether a customer is a qualified lead; implementing business decision making logic; etc.). The disclosed techniques may implement a knowledge map. The knowledge map operates as a conceptual graph connecting related knowledge sources. The related knowledge sources may be connected based on CRM interaction patterns (e.g., interactions between objects within a CRM database, such as from relationships between a customer object representing a customer, a helpdesk ticket object representing an issue of the customer, and ticket processing pipeline and workflow objects representing technical support actions performed or to perform for resolving the issue; a user interacting with various objects within the CRM database; etc.). Data, identified as LLM relevant or critically associated data, is input upfront so that the knowledge map may offload graphical search responsibilities. Offloading the graphical search responsibilities significantly reduces token usage by models, thus improving performance, reducing costs, and reducing resource consumption by the models.

In some embodiments, a method is provided. The method includes creating a knowledge box to organize contextual data provided by knowledge sources paired with the knowledge box; identifying a first service that has been assigned a first computer implemented task to perform using a model to process a prompt; in response to determining that the first service has permission to access the knowledge box, searching the knowledge box to identify select contextual data relevant to the first computer implemented task; augmenting the prompt with the select contextual data for processing by the model to generate an output for the prompt; and performing the first computer implemented task based upon the output from the model.

In some embodiments, the method includes defining the knowledge box to organize and scope the contextual data into a reusable knowledge box made accessible from a centralized contextual layer to a plurality of services for reusable retrieval of the contextual data; and defining the knowledge sources to include at least one of a customer relationship management (CRM) object, a transcript, an online storage drive, a document, user information, user interaction with a platform hosting a CRM database and the plurality of services, user interaction with an agent, emails, websites, structured data, or unstructured data.

In some embodiments, the method includes formatting the contextual data from a native format to a format tailored for prompt injection into the model, wherein the formatting includes at least one of summarization of the contextual data, JSON to natural language flattening, or chunk prioritization.

In some embodiments, the method includes selecting an amount of the contextual data as the select contextual data based upon relevancy selection criteria for context chunk filtering and selection.

In some embodiments, the method includes performing a semantic search over a vector store of a retrieval-augmented generation platform with application programming interface (API) lookups to identify the select contextual data.

In some embodiments, the method includes implementing a security and access control layer for a centralized contextual layer to specify which services of a platform are allow to access which knowledge boxes and knowledge sources managed by the centralized contextual layer, wherein the security and access control layer implements at least one of user or role based access control; and blocking, by the security and access control layer, access to the knowledge box by a second service performing a second task.

In some embodiments, the method includes subscribing to events corresponding to content changes for a content item from which the contextual data is extracted; and in response to an event indicating that the content item has a content change, updating the knowledge box based upon the content change.

In some embodiments, the method includes in response to determining that the content change is relevant to the first computer implemented task, updating the contextual data to create updated contextual data from which the select contextual data is selected.

In some embodiments, the method includes populating a management interface with contextual data upload functionality, data source connection functionality, and a visualization of the contextual data and an internal interpretation of the contextual data for understanding and managing the contextual data.

In some embodiments, a system is provided. The system includes one or more processors configured for executing instructions to perform operations comprising creating a knowledge box to organize contextual data provided by knowledge sources paired with the knowledge box; identifying a first service that has been assigned a first computer implemented task to perform using a model to process a prompt; in response to determining that the first service has permission to access the knowledge box, searching the knowledge box to identify select contextual data relevant to the first computer implemented task; augmenting the prompt with the select contextual data for processing by the model to generate an output for the prompt; and performing the first computer implemented task based upon the output from the model.

In some embodiments, the operations include identifying a set of skills available for the service for performing the computer implemented task; and generating and providing an explanation of the set of skills to the service.

In some embodiments, the operations include in response to the service invoking a skill of the set of skills, providing additional context for information provided by the skill, wherein the additional context is determined from the contextual data within the knowledge box.

In some embodiments, the operations include selecting first contextual data as the select contextual data based upon the computer implemented task relating to a read workflow; and selecting second contextual data as the select contextual data based upon the computer implemented task relating to a write workflow.

In some embodiments, the operations include formatting the select contextual data based upon a type of question of the prompt and an amount of structure of the select contextual data to create formatted contextual data input into a large language model of the service.

In some embodiments, the operations include storing contextual data of knowledge boxes within a vector database of a retrieval-augmented generation platform, wherein organizational contextual units of the knowledge boxes are tagged based upon search themes and queries; selecting a contextual chunking strategy based upon a contextual use case of the computer implemented task; and searching, based upon the prompt and a query deriving from the contextual chunking strategy, an organizational contextual unit of the knowledge box to identify the select contextual data, wherein the search is constrained to a subset of the vector database corresponding to the organizational contextual unit.

In some embodiments, the operations include receiving, through an interface provided by a centralized contextual layer, a designation of one or more content items to upload into one or more knowledge boxes hosted by a vector database; ingesting the one or more content items into the one or more knowledge boxes; implementing a contextual chunking strategy for the one or more content items to create contextual chunks of organizational contextual units; ranking the contextual chunks; and providing a contextual chunk as the select contextual data to a large language model of the service.

In some embodiments, a non-transitory machine readable medium is provided. The non-transitory machine readable medium comprises instructions for performing a method, which when executed by a machine, causes the machine to perform operations comprising creating a knowledge box to organize contextual data provided by knowledge sources paired with the knowledge box; identifying a first service that has been assigned a first computer implemented task to perform using a model to process a prompt; in response to determining that the first service has permission to access the knowledge box, searching the knowledge box to identify select contextual data relevant to the first computer implemented task; augmenting the prompt with the select contextual data for processing by the model to generate an output for the prompt; and performing the first computer implemented task based upon the output from the model.

In some embodiments, the operations include in response to an agent orchestrator receiving the prompt, creating and queuing a job; and processing, by an orchestrator worker, the job by: selecting an agent definition corresponding to a select model for solving the computer implemented task specified by the job; searching a skill library for a skill relevant to the computer implemented task based upon a knowledge map specifying skills available for the orchestrator worker for solving the computer implemented task; providing the service with access to the skill; augmenting a skill output from the skill with additional context obtained from the knowledge box to create an augmented output; and generating the output for the computer implemented task based upon the augmented output.

In some embodiments, the operations include determining a structure type of available contextual data; determining a specificity type of a query of the prompt; and selecting a contextual content source for obtaining the select contextual data based upon the structure type and the specificity type, wherein the contextual content source is selected from a set of contextual content sources including a retrieval-augmented generation platform, an application programming interface (API) endpoint, a natural language processing API endpoint, or a structured tag library.

In some embodiments, the operations include in response to detecting a user correction for the output, training a centralized contextual layer hosting the knowledge box for subsequently selecting contextual data.

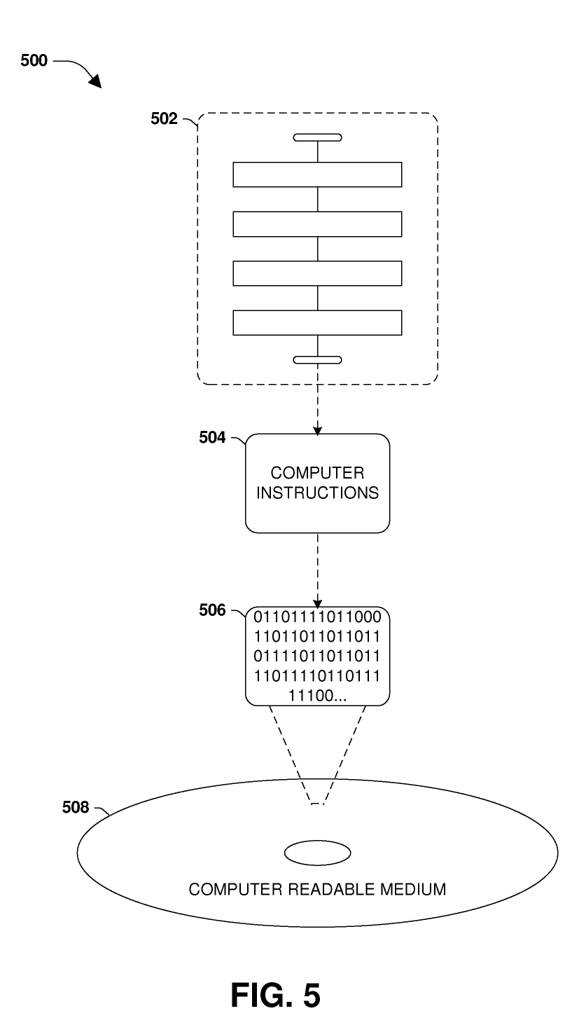

A computer-readable medium comprises processor-executable instructions configured to implement one or more of the techniques presented herein. An example embodiment of a computer-readable medium or a computer-readable device is illustrated in FIG. 5, wherein the implementation 500 comprises a computer-readable medium 508, such as a CD-R, DVD-R, flash drive, a platter of a hard disk drive, etc., on which is encoded computer-readable data 506. This computer-readable data 506, such as binary data comprising at least one of a zero or a one, in turn comprises a processor-executable computer instructions 504 configured to operate according to one or more of the principles set forth herein. In some embodiments, the processor-executable computer instructions 504 are configured to perform a method 502 (e.g., method 200), for example. In some embodiments, the processor-executable computer instructions 504 are configured to implement the system 300, for example. Many such computer-readable media are devised by those of ordinary skill in the art that are configured to operate in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims. As used in this application, the terms "component," "module," "system", "interface", and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. A component may reside within a process and/or thread of execution and a component may be localized on one computer and/or distributed between two or more computers. Furthermore, the claimed subject matter may be implemented as a method, apparatus, or article of manufacture using programming and/or engineering techniques to produce software, firmware, hardware, or any combination thereof to control a computer to implement the disclosed subject matter. The term "article of manufacture" as used herein is intended to encompass a computer program accessible from any computer-readable device, carrier, or media. Many modifications may be made to this configuration without departing from the scope or spirit of the claimed subject matter.

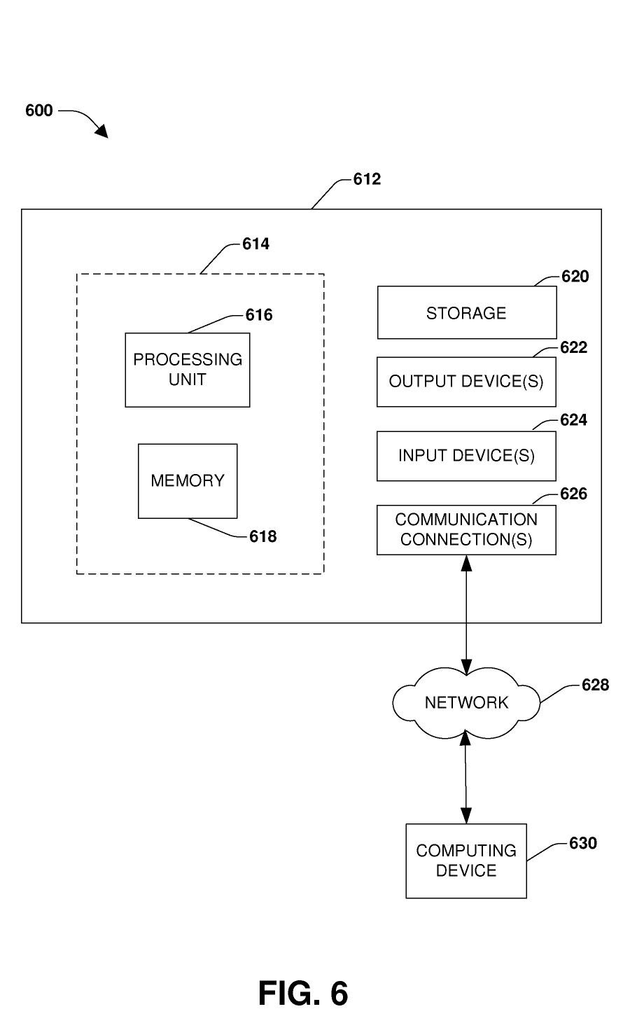

FIG. 6 and the following discussion provide a brief, general description of a suitable computing environment to implement embodiments of one or more of the provisions set forth herein. The operating environment of FIG. 6 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, etc.), multiprocessor systems, consumer electronics, mini computers, mainframe computers, distributed computing environments that include any of the above systems or devices, etc. Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, etc., that perform particular tasks or implement particular abstract data types. Typically, the functionality of the computer readable instructions may be combined or distributed as desired in various environments.

FIG. 6 illustrates an example of a system 600 comprising a computing device 612 configured to implement one or more embodiments provided herein. In one configuration, computing device 612 includes at least one processing unit 616 and memory 618. Depending on the exact configuration and type of computing device, memory 618 may be volatile (such as RAM, for example), non-volatile (such as ROM, flash memory, etc., for example) or some combination of the two. This configuration is illustrated in FIG. 6 by dashed line 614. In other embodiments, device 612 may include additional features and/or functionality. For example, device 612 may also include additional storage (e.g., removable and/or non-removable) including, but not limited to, magnetic storage, optical storage, etc. Such additional storage is illustrated in FIG. 6 by storage 620. In one embodiment, computer readable instructions to implement one or more embodiments provided herein may be in storage 620. Storage 620 may also store other computer readable instructions to implement an operating system, an application program, etc. Computer readable instructions may be loaded in memory 618 for execution by processing unit 616, for example. The term “computer readable media” as used herein includes computer storage media. Computer storage media includes volatile and nonvolatile, removable and non-removable media implemented in any method or technology for storage of information such as computer readable instructions or other data. Memory 618 and storage 620 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 612. Computer storage media does not, however, include propagated signals. Rather, computer storage media excludes propagated signals. Any such computer storage media may be part of device 612.

Device 612 may also include communication connection(s) 626 that allows device 612 to communicate with other devices. Communication connection(s) 626 may include, but is not limited to, a modem, a Network Interface Card (NIC), an integrated network interface, a radio frequency transmitter/receiver, an infrared port, a USB connection, or other interfaces for connecting computing device 612 to other computing devices. Communication connection(s) 626 may include a wired connection or a wireless connection. Communication connection(s) 626 may transmit and/or receive communication media. The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal. Device 612 may include input device(s) 624 such as keyboard, mouse, pen, voice input device, touch input device, infrared cameras, video input devices, and/or any other input device. Output device(s) 622 such as one or more displays, speakers, printers, and/or any other output device may also be included in device 612. Input device(s) 624 and output device(s) 622 may be connected to device 612 via a wired connection, wireless connection, etc. In one embodiment, an input device or an output device from another computing device may be used as input device(s) 624 or output device(s) 622 for computing device 612. Components of computing device 612 may be connected by various interconnects, such as a bus. Components of computing device 612 may be interconnected by a network. For example, memory 618 may be comprised of multiple physical memory units located in different physical locations interconnected by a network. For example, a computing device 630 accessible via a network 628 may store computer readable instructions to implement one or more embodiments provided herein.

FIG. 7 is a block diagram illustrating an example of unified platform such as a multi-service business platform 700 the includes a customer relationship management (CRM) system, a synchronization system, a machine learning system, a content management system (CMS), a multi-client service system, a customization system, an event system, a payment system, a reporting system, a conversation intelligence system, a custom workflow actions system, a workflow system, an entity resolution system, services (e.g., workflow automation, reporting, CRM-related actions, analytics, import/export, and other actions), and a multi-service business platform (e.g., multi-tenant data stores, proprietary data stores, knowledge graphs, and event data stores), which are further described in U.S. Provisional Patent Application, titled “SYSTEM AND METHOD OF TRANSLATING A TRACKING MODULE TO A UNIQUE IDENTIFIER”, filed on May 13th, 2022, which is incorporated herein by reference. The multi-service business platform 700 (the unified platform) may communicate with various devices, services, and information sources over a network.

The platform (the multi-service business platform 700) may serve the needs of multiple clients who in turn use the system to provide services, support, etc. for their customers or end users. The platform includes a Customer Relationship Management (CRM) System, a synchronization system, an Artificial Intelligence (AI)/Machine Learning (ML) system (“AI/ML system”), a content management system (CMS), a customization system, a multi-client servicing system, an event system, a payment system, a reporting system, a conversational intelligence system, a workflow system having a custom workflow actions system, an entity resolution system, a services module and a storage system.

The services module includes a workflow automation service, a CRM related action service, an import/export service, a reporting service, an analytics service and other services. Other services may include, for example, filtering used to search, filter, and list objects (e.g., contact objects) that may be used with other objects and/or create lists for other types of objects. In some examples, other services may include reporting, permissioning, auditing, user-defined calculations, and aggregations.

The storage system includes one or more multi-tenant data stores, one or more proprietary data stores, one or more knowledge graph data structures and one or more event data stores. Custom objects and/or core objects may include information that may be stored in the multi-tenant data stores of the storage system. The custom objects and/or core objects as well as possible relationships (e.g., associations) between objects may be stored in an ontology of the knowledge data structure.

The platform may communicate with external systems and data sources via a communication network (e.g., Internet, public network, private network, etc.). Specifically, the multi-service business platform may communicate with a user device(s) who is using the one or more systems of the platform (e.g. CRM, customization system) to reach their customers who are accessing the user side of the platform (content, ticketing system, etc.) via one or more user device(s). The platform may allow the client to track various activities of their customers (users) for purposes of sales and marketing (e.g. using custom objects).

The platform may refer to a computing system that provides customer service solutions for any number of different clients. As used herein, a client may refer to an organization (e.g., a business, a government agency, a non-profit, etc.) that engages in some form of commercial or service-related activity, whereby the platform may provide a customized or semi-customized customer service solution to service the customers of the client. In embodiments, the platform is a multi-tenant platform, such that the system serves the needs of multiple clients, who in turn use the system to provide service, support and the like to their own customers. As used herein, the term “service” should be understood to encompass, except where context indicates otherwise, any of a wide range of activities involved in providing services to customers and others, such as via various workflows of a business, including providing services for value, servicing goods, updating software, upgrading software, providing customer support, answering questions, providing instructions of use, issuing refunds or returns, and many others. As used herein, except where context indicates otherwise, a customer may refer to an entity or individual that engages with the client (e.g., a purchaser of a product or service of the client, a user of the client’s software platform, etc.), and the term “customer” should be understood to encompass individuals at different stages of a relationship with a client, such as individuals/organizations who are being targeted with marketing and promotional efforts, prospects who are engaged in negotiations with sales people, customers who have purchased a product, and users of the product or service (such as individuals within a customer organization). Furthermore, as will be discussed in further detail, the term “contact” is used to describe organizational entities or individuals that do engage with, may engage with, or previously engaged with the client. For example, a “contact” may refer to a sales lead, a potential customer, a closed customer (e.g., purchaser, licensee, lessee, loan recipient, policy holder, or the like), and/or a previous customer (e.g., a purchaser that needs service or may review the organization). In this way, the platform may help track a contact through an entire contact lifecycle (e.g., from the time the contact first comes to the attention of the client as a lead (such as when the client opens a promotional email or clicks on a promotional offer) until the end of the lifecycle of the client’s offering(s)). It should be noted that the term contact may refer to a customer, but also to individuals and organizations that may not qualify as “customers” or users of a client.

The platform may also communicate with one or more external information sources that may include company information or data on customers, products, sales, third party data, resource description framework (RDF) site summary (RSS) feeds or really simple syndication (RSS) feeds, telemetrics (e.g., from email, websites, app usage), etc. with respect to custom objects. The platform may also communicate with third party service(s) (e.g., third party applications, websites, data lakes and warehouses, etc.) via network.

The platform may also communicate with integrator device(s). Integrator devices may refer to user devices used by third-party integrator users that may create and may define a series of custom objects that may be integrated with other objects in the multi-service business platform and may be offered to users of the multi-service business platform. The platform may include APIs (as described in the disclosure) that a user may use to define custom objects and integrate those custom objects into the CRM system and thereby into the platform. These same APIs may be available to integrator users to do the same thing. The integrator users may define a series of custom objects, then the integrator users may define object definitions. When a client installs that integration into their instance of the platform, the client may then start creating instances of custom objects defined by the integrators.

In some embodiments, the CRM maintains records of contacts and interactions associated with a particular customer or potential customer, including relevant corporate information, named individuals in significant roles, purchasing history, etc. In some embodiments, the CRM system supports a consistent set of features and information is structured, so that individuals may be associated with corporate roles, and attributes such as progress status may be associated with objects such as product orders. Controlled change procedures may be provided to, as examples, provide auditable logs of information change activity, or to require particular authority to make such changes.

The CRM is configured to access, associate and manage objects which are associated with potential and existing contacts (or customers) which create value to the client user who is using the platform. Contact objects may be considered as people who may communicate with the client (e.g., anyone who may interact with business) such as customers or prospective customers of the business (e.g., people who may convert on a form, people who contact chat team of business, and/or people who met business team at an event). Each contact object may be defined with properties (e.g., a name of the contact, a phone number of the contact, an email address of the contact, a physical address of the contact, a title of the contact, etc.). Contacts may work at companies such that company objects may also be important to represent in data. Company objects may be defined as organizations or businesses that may communicate with a user’s organization. Each company object may include properties such as a company name, an address of the company (e.g., main location, headquarters, or the like), and other suitable properties.

A deal object may be considered opportunities that may be available from interactions with contacts (e.g., contact objects) and/or companies (e.g., company objects). Deal objects may be defined as and represent transactions that may be typically between two businesses. Each deal object may include properties such as a sale made by a customer to a company via a contact. Some examples of deal objects may include the amount of a deal (e.g., deal_amount), an estimated close date for a deal (e.g., estimated_close_date), and a likelihood to close a deal (e.g., likelihood_to_close). Likelihood to close may be determined from machine learning. For example, machine learning may be used to take previously closed deals and may create a model around what types of properties (e.g., attributes) and objects may create a highly likely result to close and then may output values based on this predictive machine learning.

In some embodiments, ticket objects may be considered as customer deals, requests for support or help (e.g., service ticket that may relate to a service request that may be issued by a company to a user via a contact). Some examples of properties for ticket objects may include date ticket was opened (e.g., date_opened), priority of ticket, last date custom replied to ticket (e.g., last_date_customer_replied), last date rep replied to ticket (e.g., last_date_rep_replied), etc.

The CRM of the platform is configured to include associations between core and customized objects. For example, each association may be a directed association, such that a respective association may define a type of relationship from a first object to a second object. For example, an association between a contact object and a company object may be “works for” such that the contact object “works for” (association) the company object. When an instance of the contact object (e.g., the contact object instance identifies Bob as a contact) may be associated with an instance of the company object (e.g., the company object instance may identify “Acme Corp.” as a the company) with a “works for” association, then the individual indicated by the company object instance may be defined in the customer databases as working for the company indicated in the company object instance (e.g., Bob works for Acme Corp.).

In example embodiments, two objects may be associated using one or more different types of associations and the associations may be directed in both directions (e.g., association and inverse association). An inverse association of the association may be created automatically for every association. For example, the association in one direction may be “works for” and the inverse association may be “employs” which may be created for the same association automatically. This same association may be viewed from the contact object and viewed from the company object such that the association may be defined as the contact object “works for” (association) the company object or the company object “employs” (inverse association) the contact object. The associations may be between the same types of objects and/or between different types of objects. For example, in continuing the example of the company object and the contact object, a contact object instance may indicate that the company defined by the company object instance may employ the individual defined by the contact object instance vis-à-vis the “employs” association (e.g., Acme Corp employs Bob) and that the individual works for the company vis-à-vis the “works for” association (e.g., Bob works for Acme Corp).

In some example embodiments, two objects may have multiple associations in the same direction. Continuing the example of the contact object and the company object, a contact object may be associated with a company object by a “works for” association, a “previously worked for” association, a “sells to” association, and/or other suitable types of associations. Similarly, the company object may be associated with a contact object with an “employs” association, a “previously employed” association, a “buys from” association, and/or other suitable types of associations. In this way, different types of relationships between instances of objects may be defined within the customer’s databases.

In example embodiments, objects may also have the same object type directed associations. For example, a contact object may be associated to itself with one or more directed associations, such as a “is supervised by” association, a “supervises” association, or the like. For example, if Bob and Alice may work for the same company and Alice may supervise Bob, then an instance of a contact object that may define Bob may be associated with a contact object instance that may identify Alice with a “is supervised by” association (e.g., Bob “is supervised by” Alice) and/or Alice’s contact object instance may be associated with Bob’s contact object instance with a “supervises” association (e.g., Alice “supervises” Bob).

The contact data record may include a contact ID, a client ID, a purchase data, ticket IDs, a contact timeline, and contact data. It is noted that the contact record may be used across multiple platforms, such that the contact record defines data relevant to the contact through the lifecycle of the contact (e.g., from new lead and/or buyer through customer service). In an example aspect, the client’s customer service function may be integrated with the sales arm of the client’s business. For example, the contact record corresponds to a warehouse manager (a contact or end user) that purchased an industrial furnace from an HVAC business (a client) may identify or otherwise reference the dates on which the warehouse manager was first contacted, all communications sent between the manager and the HVAC business, a product ID of the furnace, and any tickets that have been initiated by the contact on behalf of the warehouse, etc. Thus, in some embodiments, the integration of the client’s sales and marketing data with the client’s customer service infrastructure allows a client-specific service system to address issues with a more complete view of the contact’s data and reduces the need for APIs to connect typically unconnected systems (e.g., invoicing system, CRM, contact database, etc.). The foregoing database object is provided for example. Not all the data types discussed are required and the object may include additional or alternative data types not herein discussed.

The contact identifier (or “contact ID”) may be a unique value (e.g., string or number) that uniquely identifies the contact (user) from other contacts which the client has a probable or existing business relationship with. It is noted that the client ID is specific to a relationship between a contact and a client, whereby the contact may only relate to a single client, although the contact may related to more than one client.

If a certain individual interacts with multiple clients, then the contact may have multiple contact records associated therewith (i.e., one for each client, where the contact is a customer of different clients (businesses) for the respective products or services of the businesses). The client ID indicates the client to which the contact corresponds. In embodiments, the client ID may be a reference to the client record (e.g., client database record). In this way, the client ID defines the relationship between the contact end user and the client.

In some embodiments, purchase data indicates some or all of the purchases made by the contact end user for a respective client. In some embodiments, the purchase data may represent one or more products and/or services purchased by the contact and the dates on which such products or services were purchased from the client. In some embodiments, the products and services may be presented by product IDs which are unique identifiers for each product/service that is offered by the client.

The ticket IDs indicate any tickets that have been issued with respect to the client. In embodiments, the ticket IDs include any tickets, resolved or unresolved, that have been issued with respect to the contact for a particular client. In an embodiment, the ticket IDs may only include the tickets IDs that are still open. More details about ticket IDs are discussed below with regard to the ticketing system.

In some embodiments, the contact timeline represents data relating to a timeline documenting the contact end user’s interaction with the client. The contact timeline may include data from the point in time when the contact was solicited as a lead, when purchases were made by the contact, when tickets were generated on behalf of the contact, when communications were sent to the contact, etc.

In some embodiments, contact data object may include any data that is relevant to the contact end user customer with respect to a particular client of the platform. The contact data may include demographic data (e.g., age and sex), geographic data (e.g., address, city, state, country), conversation data (e.g., references to communications that were engaged in with the client), contact information (e.g., phone number, email address, user name), etc. Contact data may further include information such as a date that the contact was entered into the system, lifecycle state (what is the current relationship with the contact— current customer, lead, or service only), last purchase date, recent purchase dates, on boarding dates, in-person visit dates, last login, last event, last date a feature was used, demos presented to the contact, industry vertical of the contact, a role of the contact, behavioral data, net promoter score of the contact, and/or a contact score (e.g., net value of the contact to the client or a net promoter score).

Accordingly, contact data and the timeline data can be configured to provide a rich history of all interactions of the contact end user and the client over the lifecycle of their relationship. As a result, an individual, such as a salesperson or service professional, of the client using the platform can understand and reference that history for one or more end user to provide relevant communications to them.

In some embodiments, the client record may include the client ID and one or more product IDs. The client ID may be a unique value (e.g., string or number) that uniquely identifies the client from other clients that have accounts in the platform. The product IDs identify/reference products (e.g., goods, services, software) that are offered by the client. The product ID of a product may reference a product record (not shown) that includes data relating to the product, including warranty data, serial numbers, descriptions, product names and the like.

A ticket database record or ticket object is utilized and managed by the CRM system of the platform in accordance with an aspect of the present disclosure. In some embodiments, the ticket database record may include a ticket ID, the client ID, a contact ID, one or more ticket attributes, one or more status attributes, and other additional ticket data. In some embodiments, the ticket object stores data associated with the types of ticket attributes that may be used to identify, track, and/or manage a ticket issued to an end user contact on behalf of the client. The ticket ID is a unique value (e.g., string or number) that uniquely identifies each ticket from other tickets that may be associated with contacts of the client. In a ticket object, the client ID is a value that indicates the client with respect to which the ticket was issued. As can be appreciated, the client ID may point to the client database record and/or the contact record for a particular client. The contact ID uniquely identifies the contact that initiated the ticket for the particular client. As can be appreciated, the contact ID may point to the client database record of the contact that initiated the ticket.

The ticket attributes may include or reference any data tied to the ticket. As discussed, the ticket attributes may include default ticket attributes and/or custom ticket attributes. Examples of default ticket attributes may include a ticket priority attribute (e.g., high, low, or medium), a ticket subject attribute (e.g., what is the ticket concerning), a ticket description attribute, a pipeline ID attribute, a creation date attribute, a last update attribute, etc. The custom ticket attributes may depend on the customizations of the customer contact for a particular client.

In an example, the ticket attributes may be customized to include a ticket type attribute indicating a type of the ticket (e.g., service request, upgrade request, refund request, lost items, etc.), a contact sentiment attribute indicating whether a sentiment score of a contact (e.g., whether the contact is happy, neutral, frustrated, angry, etc.). In some embodiments, the ticket status attribute may include a sentiment or tone of the contact throughout the timeline, feedback from the contact, a contact score of the client, etc. In some embodiments, the product ID attribute indicates a product to which the ticket corresponds, a contact frequency attribute indicating a number of times a contact has been contacted, a media asset attribute indicating media assets (e.g., articles or videos) that have been sent to the contact during the ticket’s lifetime, etc.

In some embodiments, the ticket attributes may further include the ticket status attribute. The ticket status attribute can indicate a status of the ticket, whereby the status may be defined with respect to the ticket pipeline for the client. For example, example statuses may include: ticket is opened but not acted upon, waiting for customer response, at a chatbot stage, at service specialist, at visit stage, at refund state, issue resolved, etc.

In some embodiments, the ticket object may include additional ticket data in accordance with the CRM system of the present platform. In embodiments, the additional ticket data may include or reference the specialist or specialists that have helped service the ticket (e.g., employee IDs), any notes entered by specialists, a number of notes entered by the specialists, a list of materials that have been sent to the contact during attempts to resolve the issue, etc. In some embodiments, the additional ticket data may include references to transcripts of conversations with the contact over different mediums or knowledge base articles referred to during the handling of a ticket. For example, the additional ticket data may include or reference conversations had with a chatbot, over email, telephone call, in a WhatsApp message, SMS text message, social media posts, and/or other communications with the client’s customer service specialist. The additional ticket data may additionally or alternatively include analytics data.

Custom objects may be defined as purposely non-prescriptive objects (e.g., flexible/customizable in contrast from fixed core objects). A client may create custom objects relevant to their business and the user’s business needs. The custom objects may provide an alternative where objects of interest to businesses may not fit smoothly within core objects (e.g., not necessarily fit as contacts, companies, deals, and/or tickets). The user may create custom objects that may be particularly useful to one or more services (e.g., workflows, reporting) of the multi-service business platform as described in the disclosure.

Each custom object or custom object definition may include an object type, properties (e.g., some properties may be set on an instance), and possible associations. In example embodiments, custom objects and/or types of custom objects may include products, goods such as devices/machines (e.g., cars, drones, boats, mobile phones, etc. such that these devices/machines custom objects may be used to track details about ownership, service, cost of devices/machines), business services, shipments (e.g., may be used to store data about fulfillment of orders that may be intended to be sent out), applications (e.g., may be used to store data that tracks progress of an application), projects (e.g., may be used to store data about work or deliverables), locations/stores (e.g., may be used to store granular data about companies and their many physical locations such as store locations and/or company headquarters location), customer locations (e.g., may be locations of customers that buy products and/or services from user’s business), events (e.g., may be used to store and track physical or online events a company holds), listings (e.g., may be used to store data about real estate listings for a real estate company), referrals (e.g., may be used to link two things together to notate a referral or referrer), etc. Some businesses may have unique relationships from operating in an agency type model that the businesses may want to identify, monitor, and/or track using custom objects.

Custom objects may provide users with the ability to model their business. For example, custom objects may allow users to model their own version of contacts, companies, deals, and/or tickets or any other type of object for their businesses that may allow the users to customize what they want for objects and/or object types. The custom objects may be used with the multi-service business platform such that the upstart of the platform may provide various functionality for usage of these custom objects. When a user may build a custom object, the user may utilize all services (e.g., features) of the platform such that the user (e.g., user’s business) may use these services throughout the platform towards relevant custom objects that may match user’s business needs.

In some examples, users may create custom objects with respect to usefulness with services of the multi-service business platform. For example, an auto manufacturer user may create car or vehicle custom objects that may fit into the auto manufacturer’s business workflows (e.g., workflow automation) that may be used on the platform. In another example, a user may choose to add custom objects that may be particularly useful with reporting service for user’s business needs.

In general, this ability to create custom objects provides increased and improved customizability across the multi-service business platform. This provides several advantages to the platform as described in the disclosure. For example, some advantages may include customization for users with respect to their business industry or field, specific customization towards each user’s business itself such that one user in a business industry (e.g., car industry) may have different custom object needs with respect to another user in the same business industry, increased speed of development of various new types of objects by users and by developers of the multi-service business platform, etc.

Using a yoga business as an example (e.g., where the user may be a yoga business owner), the user may create custom objects towards their yoga business (e.g., where the yoga business may include multiple studios that may be staffed with multiple instructors that may teach different classes that may be taught to students in accordance with the instructors’ respective schedules). In this example, a user (e.g., a user affiliated with the yoga studio or a third-party consultant) may create (e.g., via a GUI) a set of custom objects that relate to the yoga business, including defining the properties of each custom object. For example, the custom objects created may be studio objects, class objects, instructor objects, student objects, and schedule objects. Each studio custom object may include properties such as address of studio, rent of studio, and date when studio opened (e.g., date_opened). Each class custom object may include properties such as name of class, price of class, and schedule of class. Each instructor custom object may include properties such as date when instructor was hired (e.g., date_hired), latest certification date of instructor (e.g., latest_certification_date), certification expiration date of instructor (e.g., certification_expiration_date), and number of classes taught by instructor (e.g., number_of_classes_taught). Each student custom object may include properties such as date joined by student (e.g., date_joined), number of classes attended by student (e.g., number_of_classes_attended), date last attended a class by student (e.g., date_last_attended_a_class), total lifetime value of student (e.g., total_lifetime_value), credit of student, address of student, and phone number of student.

One or more techniques and/or computing devices for implementing an artificial intelligence / machine learning (AI/ML) copilot (e.g., an AI/ML concierge) are provided, which may be implemented as a service to which contextual data is provided by the centralized contextual layer. That is, the AI/ML copilot may be a service of the platform 102, and the centralized contextual layer provides contextual data to models used by the AI/ML copilot for operation.

The AI/ML copilot (a service) includes a chat interface, which allows users to input natural language commands that are processed using the power of AI/ML copilot. In this way, the AI/ML copilot is hosted as a conversational CRM chatbot. The AI/ML copilot can generate a wide variety of outputs based upon the natural language commands, such as programmatically generating reports, a blog on a particular topic, a presentation slide, a spreadsheet, images, software code, emails, contacts, etc. With AI/ML copilot, a user can complete a task using a declarative approach where the user inputs a natural language statement as a command/query that describes an outcome (e.g., “create a helpdesk service ticket about my dropped phone calls”), but does not include the actual functional steps or code to achieve the outcome. Instead, the AI/ML copilot takes the natural language statement as input, and generates and performs the functional steps or code that produces the outcome described by the natural language statement.

The AI/ML copilot utilizes the power of generative AI and a CRM database to create an all-in-one AI powered tool that can accomplish any task related to a multi-client service system platform such a multi-service business platform of FIG. 7. A user can ask the AI/ML copilot to perform tasks by inputting natural language statements/commands through the chat interface. With this integration of generative AI and data from the CRM database, the AI/ML copilot can perform tasks such as adding contacts into the CRM database (e.g., the AI/ML copilot will identify and populate relevant properties within contacts objects in the CRM database to reduce manual data entry that can be error prone), generating custom reports (e.g., reports related to marketing, sales, and customer service), drafting personalized emails that are tailored to a recipient (e.g., draft a follow-up email for a prospect, draft a thank you note, creating a marketing email using campaign information in the CRM database, etc.), creating original IA images for blog articles, scheduling a task to be performed, and a wide variety of other tasks related to the modules/systems of the multi-client service system platform. In this way, the user no longer needs to interface with a CRM application in order to view and interact with data and perform tasks. This significantly streamlines the user’s interaction with the multi-client service system platform by providing a single chat interface through which the user can utilize natural language statements that invoke the generative AI to perform tasks related to the multi-client service system platform on behalf of the user (e.g., new contacts, emails, reports, spreadsheets, presentations, and/or other content can be created on the fly without manual data entry that can otherwise be error prone and cause erroneous data to be stored within the CRM database).

In some embodiments, the AI/ML copilot is linked to other various modules a multi-client service system platform such as data sources (e.g., a website, a customer relationship management database, an image repository, etc.), applications (e.g., a spreadsheet application, a presentation application, a word processing application, a social network application, a messaging application, etc.), and services (e.g., an email service) in order to enhance the capabilities of the chat interface. In some embodiments, the AI/ML copilot links to a customer relationship management (CRM) system in order to leverage information within the CRM system and to populate new information within the CRM system (e.g., create tasks, create contacts, view marketing information, perform various analysis on sales data, create reports, etc.) based upon natural language commands input through the chat interface. In some embodiments, the AI/ML copilot and/or the chat interface may be integrated into and/or is a part of the multi-client service system platform.

The AI/ML copilot may implement various application programming interfaces (APIs) in order to interface with the modules/systems of the multi-client service system platform (e.g., an API used to access the CRM system, a REST API to access a service accessible over a network, etc.). The AI/ML copilot may link to various applications, services, and content such as a spreadsheet application, a word processing application, a presentation application, a blogging service, a social network service, websites, databases, an image repository, social network profiles and posts, and/or other content in order to process natural language commands input through the chat interface.

In an embodiment, the AI/ML copilot links to an artificial intelligence system of an integrator app that can create images and art from descriptions submitted through the chat interface in natural language. In another embodiment, the AI/ML copilot links to another integrator app such as a keyword research service or tool that provides topics and content (e.g., ideas, concepts, topics, paragraphs of text, sentences of text, etc.) related to natural language commands input through a chat interface of the AI/ML copilot.

When a user inputs a natural language command through the chat interface (e.g., “create a helpdesk service ticket about my dropped phone calls;” “creating a report about company ABC;” etc.), the AI/ML copilot automatically selects certain modules, corresponding to the platforms, data sources, applications, and/or services, to utilize for processing the natural language command (e.g., selecting a certain order of modules and systems of the multi-service business platform to invoke). The natural language command may describe a desired outcome such as the report about the company ABC, which may be used by the AI/ML copilot to select one or more of the modules to utilize for generating the desired outcome. The desired outcome, derived from the natural language command, may be used to select an order with which to access/invoke the modules, what inputs to input into each module (e.g., an output from one module may be used as an input to another module), and what outputs are expected from each module. For example, a CRM system and storage system, a website of the company ABC, a business information repository, a social network service hosting a social network profile of the company ABC, and/or other modules or content may be selected in order to obtain information that the AI/ML copilot will use to generate the report. In this way, natural language commands input through the chat interface are used by the AI/ML copilot to select, order, and/or invoke certain modules (systems) in order to generate content using artificial intelligence, machine learning, and/or various types of models, which can be used by business growth professionals such as customer service agents, executives, a marketing team, a sales team, and/or a wide variety of other types of users.

A chat interface is powered by the AI/ML copilot (e.g., an AI/ML concierge) of the platform. The chat interface may be populated with a natural language input interface through which a user can input natural language commands to the AI/ML copilot. The chat interface may include a suggestions interface. The AI/ML copilot may generate suggested natural language commands to populate within the suggestions interface based upon a role of the user (e.g., the user may be part of a marketing, sales, IT, or management team of a company), a location of the user, prior natural language commands submitted by the user (e.g., the user may have recently submitted natural language commands to add new contacts from a contact spreadsheet into a storage system), an employer of the user, information within emails of the user (e.g., a work email may indicate that the user is to add certain people as new contacts into the storage system), information within a social network profile of the user, a web browser search history of the user, a purchase history of the user, information accessible through a module (e.g., information accessible through a CRM System, information within the spreadsheet accessible through a spreadsheet application or online spreadsheet hosting service, etc.), etc.

The suggestions interface may be populated with the suggested natural language commands that a user can select for inserting into the natural language input interface, such as “how many total contacts are there?”, “show monthly summary of web visits last year”, “add contact...”, “send that to me as a daily email update”, “where do I find a report on my social media performance”, “report of companies summarized by industry”, etc. In response to the user selecting a suggested natural language command through the suggestions interface, the suggested natural language command may be auto populated within the natural language input interface. In some embodiments, the suggested natural language command may be auto submitted through the natural language input interface or merely populated within the natural language input interface for further user editing.

In some embodiments, the user may input a first natural language command “add contact john doe, john.doe@mail.com, 111 science way, cleveland ohio, follow-up in 3 days” into the natural language input interface. In response to the user submitting the first natural language command through the natural language input interface 104, the AI/ML copilot may parse the first natural language command using various parsing functionality (e.g., a declarative programming model or other functionality used to identify desired outcomes described in natural language, entity recognition functionality, semantic parsing, topic identification functionality, text classification functionality, deep learning-based text understanding, natural language processing functionality, machine learning, etc.). The AI/ML copilot evaluates the first natural language command using artificial intelligence, declarative programming models, and/or other machine learning in order to determine what functions and/or programming code to perform and what modules/systems (e.g., systems of the multi-service business platform of FIG. 7) to use in order to achieve/generate the desired outcome. In some embodiments, the AI/ML copilot may identify a desired outcome of creating a contact for John Doe, along with a task of following up in 3 days with John Doe.

The AI/ML copilot may identify a module (system) corresponding to the CRM system that could be used as part of completing the desired outcome. The AI/ML copilot may generate an output 106 by generating a contact in a particular format that could be used to create and store a contact within the CRM System. The AI/ML copilot may capitalize certain words, fill in missing information (e.g., add a zip code), query external data sources or modules in order to identify additional/supplementary information to include within the contact (e.g., retrieve a photo of John Doe from a social network profile), and/or perform other processing upon the first natural language command in order to create the contact. The AI/ML copilot may display the output of the contact through the chat interface. The AI/ML copilot may populate the output with a View in CRM interface element and an Add Note to Contact interface element. The user may utilize the Add Note to Contact interface element in order to add notes and/or edit the contact generated by the AI/ML copilot. The user may utilize the View in CRM interface element in order to invoke the AI/ML copilot to utilize various APIs in order to add the contact into the CRM System. Additionally, the user may be transitioned to a CRM application that displays the contact added to the CRM System. The CRM application may allow the user to view the contact, emails received by the contact, calls made to the contact, tasks related to the contact, meetings scheduled with the contact, activities related to the contact such as the task created by the AI/ML copilot for a later date or time period to follow-up with the contact, etc.

A chat interface is powered by AI/ML copilot. The chat interface may be populated with a natural language input interface and a suggestions interface. The user may input a second natural language query “lookup company ABC” into the natural language input interface. The AI/ML copilot may parse the second natural language query using various parsing functionality in order to identify a desired outcome of creating a company overview for Company ABC. The AI/ML copilot may utilize the desired outcome and/or information parsed from the second natural language query in order to determine what functions and/or programming code to implement, which modules (systems) to utilize, what inputs to input into the modules, an order with which to utilize the modules, whether outputs from certain modules should be used as inputs for other modules, and/or how to format and/or combine the outputs for generating the desired outcome. In this way, the AI/ML copilot creates an output of the company overview for Company ABC for display through the chat interface. The output may be populated with information retrieved from various modules (e.g., a website of Company ABC, a social network service hosting a social network profile of Company ABC, information about Company ABC within the Storage System, SEC filing data for Company ABC, news articles related to Company ABC, etc.). The output may be populated with a number of employees, a company description, a founding year, a location, a link to a social network profile of Company ABC, and/or other information related to Company ABC.

A chat interface is powered by the AI/ML copilot. The chat interface 130 may be populated with a natural language input interface 134 and a suggestions interface 132. The user may input a third natural language query “find companies in cleveland ohio with over 1k employees” into the natural language input interface 134. The AI/ML copilot may parse the third natural language query using various parsing functionality in order to identify a desired outcome of generating a list of companies located in Cleveland, Ohio that have over 1,000 employees. The AI/ML copilot may utilize the desired outcome and/or information parsed from the third natural language query in order to determine what functions and/or programming code to implement, which modules to utilize, what inputs to input into the modules, an order with which to utilize the modules, whether outputs from certain modules should be used as inputs for other modules, and/or how to format and/or combine the outputs for generating the desired outcome. In this way, the AI/ML copilot creates an output of the list of companies for display through the chat interface. The output may be populated with information retrieved from various modules, such as information from the storage system relating to companies located in Cleveland, Ohio with over 1,000 employees. The output may also be populated with lookup links to perform web searches for additional information associated with each company (e.g., a hyperlink to search results for a company’s name).

A chat interface is powered by AI/ML copilot. The chat interface may be populated with a natural language input interface and a suggestions interface. The user may input a fourth natural language query “create report of companies added in Q4 grouped by country” into the natural language input interface. The AI/ML copilot may parse the fourth natural language query using various parsing functionality in order to identify a desired outcome of generating a company report that lists the number of companies added as clients in the 4th quarter of a current year where the list is grouped by different countries. The AI/ML copilot may utilize the desired outcome and/or information parsed from the fourth natural language query in order to determine what functions and/or programming code to implement, which modules to utilize, what inputs to input into the modules, an order with which to utilize the modules, whether outputs from certain modules should be used as inputs for other modules, and/or how to format and/or combine the outputs for generating the desired outcome. In this way, the AI/ML copilot creates an output of the company report for display through the chat interface. The output may be populated with information retrieved from various modules, such as information from the storage system relating to companies that were added as clients in the 4th quarter of a current year. The AI/ML copilot may reformat and/or group the information from the storage system based upon countries for inclusion within the company report.

The user may subsequently submit a fifth natural language query of “update report and only include countries in South America” through the natural language input interface while the company report is displayed as the output through the chat interface. Accordingly, the AI/ML copilot may parse the fifth natural language query using various parsing functionality in order to identify a desired outcome of updating the company report by filtering out countries that are not included within South America. The AI/ML copilot may utilize the desired outcome and/or information parsed from the fifth natural language query in order to determine what functions/codes to implement, which modules to utilizes, what inputs to input into the modules, an order to which to utilizes the modules, whether outputs from certain modules should be used as inputs for other modules, and/or how to format and/or combine the outputs for generating the desired outcome. In this way, the AI/ML copilot creates an updated output of an updated company report for display through the chat interface.

A chat interface is powered by the AI/ML copilot. The chat interface may be populated with a natural language input interface and a suggestions interface. The user may input a sixth natural language query “show me monthly summary of web visits for last year” into the natural language input interface. The AI/ML copilot may parse the sixth natural language query using various parsing functionality in order to identify a desired outcome of generating a monthly summary of users visiting a website of the user during the prior year (2022). The AI/ML copilot may utilize the desired outcome and/or information parsed from the sixth natural language query in order to determine what functions and/or programming code to implement, which modules to utilize, what inputs to input into the modules, an order with which to utilize the modules, whether outputs from certain modules should be used as inputs for other modules, and/or how to format and/or combine the outputs for generating the desired outcome. In this way, the AI/ML copilot creates an output of the monthly summary for display through the chat interface. The output may be populated with information retrieved from various modules, such as information from the storage system relating to users visiting the user’s website.

A chat interface is powered by AI/ML copilot. The chat interface may be populated with a natural language input interface and a suggestions interface. The user may input a seventh natural language query “send this to me as an email” into the natural language input interface while an output of a company list is displayed through the chat interface. The AI/ML copilot may parse the seventh natural language query using various parsing functionality in order to identify a desired outcome of the chat interface constructing and sending an email to an email address of the user where the email includes the company list as either an attachment or within a body of the email. The AI/ML copilot may utilize the desired outcome and/or information parsed from the seventh natural language query in order to determine what functions and/or programming code to implement, which modules to utilize (e.g., an email service), what inputs to input into the modules, an order with which to utilize the modules, whether outputs from certain modules should be used as inputs for other modules, and/or how to format and/or combine the outputs for generating the desired outcome. In this way, the AI/ML copilot generates the email and transmits the email through an email service to a recipient.

A chat interface is powered by AI/ML copilot. The chat interface may be populated with a natural language input interface and a suggestions interface. The user may input an eighth natural language query “draft a blog about social network marketing and a.i. and add image of camera” into the natural language input interface. The AI/ML copilot may parse the eighth natural language query using various parsing functionality in order to identify a desired outcome of creating a blog describing how artificial intelligence is used in social network marketing, which includes an image of a camera.

The AI/ML copilot may utilize the desired outcome and/or information parsed from the eighth natural language query in order to determine what functions and/or programming code to implement, which modules to utilize (e.g., a keyword research service, a text generation service, an image generation service, etc.), what inputs to input into the modules, an order with which to utilize the modules, whether outputs from certain modules should be used as inputs for other modules, and/or how to format and/or combine the outputs for generating the desired outcome. In this way, the AI/ML copilot creates an output 186 of the blog with text describing how artificial intelligence is used in social network marketing and with the image of a camera. The blog may have a certain length, reading level, and/or format (e.g., bullet points, outline, etc.) derived from the desired outcome. The output may be populated with an Upload Blog interface element that the user can click in order to upload/post the blog to a website, blogging service, etc. The output 186 may be populated with an Edit interface element that the user can click in order to transition into a blog editor interface for modifying the text and/or the image of the camera.

A chat interface is powered by AI/ML copilot. The chat interface may be populated with a natural language input interface and a suggestions interface. The user may input a ninth natural language query “what keywords is website ranking for” into the natural language input interface. The AI/ML copilot may parse the ninth natural language query using various parsing functionality in order to identify a desired outcome of creating a report that lists information about keywords associated with a website of the user. The AI/ML copilot may utilize the desired outcome and/or information parsed from the ninth natural language query in order to determine what functions and/or programming code to implement, which modules to utilize, what inputs to input into the modules, an order with which to utilize the modules, whether outputs from certain modules should be used as inputs for other modules, and/or how to format and/or combine the outputs for generating the desired outcome. In this way, the AI/ML copilot creates an output of a report about the keywords associated with the website, which may include the keywords, a search volume for the keywords, a cost per click for the keywords, and/or links to landing pages for the keywords. The output may be populated with an Export to Spreadsheet interface element that the user can click in order to export the report into a spreadsheet hosted by a spreadsheet service. The output may be populated with an Export to Presentation interface element that the user can click in order to export the report into a presentation hosted by a presentation application.

In some embodiments, a method is implemented by a system. The system may comprise a storage system that includes a customer relationship management (CRM) database. In some embodiments, the CRM database may be hosted by the multi-service business platform of FIG. 7. The CRM database may store contacts, service tickets (e.g., customer service tickets created for tracking customer service calls, chats, issues, and resolutions), company information, contracts, business opportunities, and/or a wide variety of data as objects such as core objects natively supported by the CRM database and custom objects defined by users because the custom objects are not natively defined by the CRM database. The system may comprise a multi-client service system (e.g., the multi-service business platform of FIG. 7 or any other portion/component/system/etc.). The multi-client service system includes the AI/ML copilot configured to host the chat interface.

In some embodiments, the AI/ML copilot includes a suggestion interface populated with suggested natural language commands. In some embodiments, the suggested natural language commands may be determined based upon commands supported by the CRM database (e.g., an add contact command, a create custom object command, a delete object command, a command to edit fields or values within an object, etc.). In some embodiments, the suggested natural language commands may be determined based upon commands supported by applications accessible to the AI/ML copilot such as a create spreadsheet command, an open presentation command, a create social network post, an edit blog post, a generate AI image and add to an existing blog, a generate and display report command, etc. In some embodiments, the suggested natural language commands may be determined based upon prior conversations between a user and the AI/ML copilot (e.g., the user may have previously asked about reviews for bikes, and thus a suggested natural language command may relate to purchasing a bike, a command to generate a social network post asking for bike recommendations, etc.). In some embodiments, the suggested natural language commands may be determined based upon other information such as demographics of the user, a role of the user (e.g., the user may be in charge of purchasing coffee beans for a grocery store, and thus a command may relate to generate a report regarding coffee prices, purchase history, current inventory, etc.).

In some embodiments, the AI/ML copilot may be populated with a toggle option. The toggle option may transition the AI/ML copilot between a manual creation mode and an AI generated content mode. While in the manual creation mode, a user can input content through the chat interface and/or other input interfaces (e.g., an upload image interface for uploading an image, an upload document interface for uploading a file or document, or other content creation/upload interfaces for inputting content through the AI/ML copilot). The AI/ML copilot may utilize the content to perform various tasks such as creating and populating information into an object within the CRM database, a spreadsheet, a presentation, a blog, a social network post, an email, etc. While in the AI generated content mode, the AI/ML copilot may generate text, images, audio, objects within the CRM database, presentation slides, spreadsheet entries, blogs, social network posts, emails, and/or other content based upon input received through the chat interface.

A natural language command may be received through the chat interface of the AI/ML copilot. For example, the user may input “how many customers have been invoiced within the past 6 months” into the chat interface. The AI/ML copilot utilizes various AI models to parse the natural language command to determine a desired outcome (e.g., a generative pre-trained transformer model, a bidirectional encoder representations for transformers model, a pathways language model, an OpenAI model, or any other type of model that can interpret text input). For example, the AI/ML copilot may utilize one or more AI models to determine a desired outcome that a report is to be generated from data stored within customer objects and invoicing objects within the CRM database, and the report is to include a count of customers that were invoiced over the past 6 months, where the report could be generated as a single number, a list of the customers, or some other format of information.

Programming code is generated for execution to achieve the desired outcome. The programming code may include database commands (e.g., SQL commands) that can be executed against the CRM database to extract information from the customer objects and invoicing objects. The programming code may include code to create a report such as a count and list of the customers that were invoiced over the past 6 months. The programming code may include code to open a spreadsheet application, create a new spreadsheet, populate the spreadsheet with the report, save a copy of the spreadsheet, and display the spreadsheet application with the spreadsheet to the user.

Other programming code may be generated for other natural language commands and desired outcomes, such as programming code to generate an image and text, access a blogging site, create a blog, include the generated image and text within the blog, and publish the blog. In some embodiments, programming code is created to generate an image and/or text, access an email service, create an email, include the generated image and/or text within the email (e.g., attach the generated image to the email and/or populate a subject and body of the email with the text), and send the email. In some embodiments, programming code is created to generate an image and/or text, access a social network service, create a post, include the generated image and/or text within the post, and publish the post. In some embodiments, programming code is created to generate an image and/or text, access a presentation application, create a presentation, include the generated image and/or text within the presentation, and save the presentation. In some embodiments, programming code is created to generate database commands for performing operations directed to the CRM database, such as creating objects, modifying objects, reading data from objects, deduplicating objects (e.g., identify similar or the same objects (redundant objects) and retaining merely one of the objects), etc.

The programming code is executed to generate content related to the desired outcome. In some embodiments, the programming code is executed to interact with objects within the CRM database. For example, the programming code may create a new object, delete an object, read information from an object, write to an object, modify an object, deduplicate an object with respect to other similar/redundant objects, etc. The content is displayed through the chat interface. In some embodiments, the natural language command, the programming code, and/or the content may relate to an external application, service, or website. Accordingly, the AI/ML copilot may transition the user from the chat interface to an external application, service, or website. In some embodiments, the AI/ML copilot may transition the user to a CRM application populated with data stored within the CRM database (e.g., a view of objects created by the AI/ML copilot). In some embodiments, the AI/ML copilot may transition the user to a spreadsheet application displaying a spreadsheet generated and populated by the AI/ML copilot using information within the content displayed through the chat interface and/or other content generated/retrieved based upon the natural language command. In some embodiments, the AI/ML copilot may transition the user to a presentation application displaying a presentation generated and populated by the AI/ML copilot using information within the content displayed through the chat interface and/or other content generated/retrieved based upon the natural language command. In some embodiments, the AI/ML copilot may transition the user to a blogging service displaying a blog generated by the AI/ML copilot using information within the content displayed through the chat interface and/or other content generated/retrieved based upon the natural language command.

In some embodiments, the AI/ML copilot may transition the user to a social media service displaying a social media post generated by the AI/ML copilot using information within the content displayed through the chat interface and/or other content generated/retrieved based upon the natural language command.

In some embodiments, the AI/ML copilot may transition the user to a forum displaying a forum post generated by the AI/ML copilot using information within the content displayed through the chat interface and/or other content generated/retrieved based upon the natural language command.

In some embodiments, the AI/ML copilot may transition the user to an email application or service displaying an email generated by the AI/ML copilot using information within the content displayed through the chat interface and/or other content generated/retrieved based upon the natural language command.

In some embodiments, the AI/ML copilot executes a database command to modify the CRM database based upon receiving a chat-based command through the chat interface. In some embodiments, the AI/ML copilot creates a new contact object within the CRM database based upon receiving a chat-based command through the chat interface. In some embodiments, the AI/ML copilot creates and sends an email based upon receiving a chat-based command through the chat interface. In some embodiments, the AI/ML copilot obtains/generates and displays a report generated from objects within the CRM database based upon receiving a chat-based command through the chat interface. In some embodiments, the AI/ML copilot deduplicates objects within the CRM database based upon receiving a chat-based command through the chat interface. In some embodiments, the AI/ML copilot automatically captures and transcribes a recorded conversation to create a transcript for the user based upon receiving a chat-based command through the chat interface (e.g., a text based transcription may be generated from an audio or video recording). In some embodiments, the AI/ML copilot logs and segments email contact information based upon receiving a chat-based command through the chat interface (e.g., segmenting similar contacts, represented by objects within the CRM database, into groups based upon demographics or other information indicative of whether two contacts are similar or dissimilar – age, gender, job title, company, purchase history, potential customer, etc.).

In some embodiments, the AI/ML copilot imports contact and company information from a spreadsheet by mapping each cell of the spreadsheet to CRM properties of objects within the CRM database based upon receiving a chat-based command through the chat interface (e.g., a cell of the spreadsheet may store a phone number that may be imported into a phone number field of a contact object or vice versa; a contact object may include an address field storing an address that may be imported into a cell of the spreadsheet; etc.). In some embodiments, the AI/ML copilot generates a follow-up email based upon information within the objects in the CRM database based upon receiving a chat-based command through the chat interface (e.g., an object may describe a contract being negotiated by the user with a client, and thus contract information from the object may be used to generate a follow-up email to the client). In some embodiments, the AI/ML copilot generates and includes an image within a blog article based upon receiving a chat-based command through the chat interface. In some embodiments, the AI/ML copilot generates a customer report using information from the objects within the CRM database based upon receiving a chat-based command through the chat interface.

In some embodiments, a system is provided. The system includes a customer relationship management (CRM) database; and a multi-client service system platform that includes an artificial intelligence and machine learning (AI/ML) copilot (e.g., an AI/ML concierge) configured to host a chat interface, wherein the AI/ML copilot performs operations including: receiving a natural language command through the chat interface; parsing the natural language command using AI/ML parsing functionality to determine a desired outcome; generating programming code for execution to achieve the desired outcome; executing the programming code to generate content related to the desired outcome, wherein the programming code interacts with objects within the CRM database; and displaying the content through the chat interface.

In some embodiments, the AI/ML copilot displays a suggestion interface populated with suggested natural language commands.

In some embodiments, the AI/ML copilot transitions a user from the chat interface to a CRM application.

In some embodiments, the AI/ML copilot transitions a user from the chat interface to a spreadsheet application displaying a spreadsheet generated and populated by the AI/ML copilot using information within the content displayed through the chat interface.

In some embodiments, the AI/ML copilot transitions a user from the chat interface to a presentation application displaying a presentation generated and populated by the AI/ML copilot using information within the content displayed through the chat interface.

In some embodiments, the AI/ML copilot transitions a user from the chat interface to a blog service displaying a blog generated by the AI/ML copilot using information within the content displayed through the chat interface.

In some embodiments, a method is provided. The method includes receiving a natural language command through a chat interface hosted by an artificial intelligence and machine learning (AI/ML) copilot (e.g., an AI/ML concierge) of a multi-client service system platform; parsing the natural language command using AI/ML parsing functionality to determine a desired outcome; generating programming code for execution to achieve the desired outcome; executing the programming code to generate content related to the desired outcome, wherein the programming code interacts with objects within a customer relationship management (CRM) database of a storage system; and displaying the content through the chat interface.

In some embodiments, the method includes providing, through the chat interface, a toggle option to toggle between manual creation and AI generated content by the AI/ML copilot for creating new content.

In some embodiments, the method includes in response to the AI/ML copilot receiving a chat-based command through the chat interface, executing a database command to modify the CRM database.

In some embodiments, the method includes in response to the AI/ML copilot receiving a chat-based command through the chat interface, creating a new contact object within the CRM database.

In some embodiments, the method includes in response to the AI/ML copilot receiving a chat-based command through the chat interface, creating and sending an email.

In some embodiments, the method includes in response to the AI/ML copilot receiving a chat-based command through the chat interface, obtaining and displaying a report generated from the objects within the CRM database.

In some embodiments, the method includes in response to the AI/ML copilot receiving a chat-based command through the chat interface, deduplicating the objects within the CRM database.

In some embodiments, the method includes in response to the AI/ML copilot receiving a chat-based command through the chat interface, automatically capturing and transcribing a recorded conversation to create a transcription.

In some embodiments, the method includes in response to the AI/ML copilot receiving a chat-based command through the chat interface, logging and segmenting email contact information.

In some embodiments, the method includes in response to the AI/ML copilot receiving a chat-based command through the chat interface, importing contact and company information from a spreadsheet by mapping each cell of the spreadsheet to a CRM property of the objects within the CRM database.

In some embodiments, a non-transitory machine readable medium is provided. The non-transitory machine readable medium stores instructions that when executed facilitate performance of operations including receiving a natural language command through a chat interface hosted by an artificial intelligence and machine learning (AI/ML) copilot (e.g., an AI/ML concierge) of a multi-client service system platform; parsing the natural language command using AI/ML parsing functionality to determine a desired outcome; generating programming code for execution to achieve the desired outcome; executing the programming code to generate content related to the desired outcome, wherein the programming code interacts with objects within a customer relationship management (CRM) database of a storage system; and displaying the content through the chat interface.

In some embodiments, the operations include in response to the AI/ML copilot receiving a chat-based command through the chat interface, generating a follow-up email based upon information within the objects in the CRM database.

In some embodiments, the operations include in response to the AI/ML copilot receiving a chat-based command through the chat interface, generating and including an image within a blog article.

In some embodiments, the operations include in response to the AI/ML copilot receiving a chat-based command through the chat interface, generating a custom report using information from the objects within the CRM database.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein. Also, it will be understood that not all operations are necessary in some embodiments. Further, unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object. Moreover, "exemplary" is used herein to mean serving as an example, instance, illustration, etc., and not necessarily as advantageous. As used herein, "or" is intended to mean an inclusive "or" rather than an exclusive "or". In addition, "a" and "an" as used in this application are generally construed to mean "one or more" unless specified otherwise or clear from context to be directed to a singular form. Also, at least one of A and B and/or the like generally means A or B and/or both A and B. Furthermore, to the extent that "includes", "having", "has", "with", and/or variants thereof are used in either the detailed description or the claims, such terms are intended to be inclusive in a manner similar to the term "comprising”.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

What is claimed is:

1. A method, comprising:
creating a knowledge box to organize contextual data provided by knowledge sources paired with the knowledge box;
identifying a first service that has been assigned a first computer implemented task to perform using a model to process a prompt;
in response to determining that the first service has permission to access the knowledge box, searching the knowledge box to identify select contextual data relevant to the first computer implemented task;
augmenting the prompt with the select contextual data for processing by the model to generate an output for the prompt; and
performing the first computer implemented task based upon the output from the model.

2. The method of claim 1, comprising:
defining the knowledge box to organize and scope the contextual data into a reusable knowledge box made accessible from a centralized contextual layer to a plurality of services for reusable retrieval of the contextual data; and
defining the knowledge sources to include at least one of a customer relationship management (CRM) object, a transcript, an online storage drive, a document, user information, user interaction with a platform hosting a CRM database and the plurality of services, user interaction with an agent, emails, websites, structured data, or unstructured data.

3. The method of claim 1, comprising:
formatting the contextual data from a native format to a format tailored for prompt injection into the model, wherein the formatting includes at least one of summarization of the contextual data, JSON to natural language flattening, or chunk prioritization.

4. The method of claim 1, comprising:
selecting an amount of the contextual data as the select contextual data based upon relevancy selection criteria for context chunk filtering and selection.

5. The method of claim 1, comprising:
performing a semantic search over a vector store of a retrieval-augmented generation platform with application programming interface (API) lookups to identify the select contextual data.

6. The method of claim 1, comprising:
implementing a security and access control layer for a centralized contextual layer to specify which services of a platform are allow to access which knowledge boxes and knowledge sources managed by the centralized contextual layer, wherein the security and access control layer implements at least one of user or role based access control; and
blocking, by the security and access control layer, access to the knowledge box by a second service performing a second task.

7. The method of claim 1, comprising:
subscribing to events corresponding to content changes for a content item from which the contextual data is extracted; and
in response to an event indicating that the content item has a content change, updating the knowledge box based upon the content change.

8. The method of claim 7, comprising:
in response to determining that the content change is relevant to the first computer implemented task, updating the contextual data to create updated contextual data from which the select contextual data is selected.

9. The method of claim 1, comprising:
populating a management interface with contextual data upload functionality, data source connection functionality, and a visualization of the contextual data and an internal interpretation of the contextual data for understanding and managing the contextual data.

10. A system, comprising:
one or more processors configured for executing instructions to perform operations comprising:
creating a knowledge box to organize contextual data provided by knowledge sources paired with the knowledge box;
identifying a service that has been assigned a computer implemented task to perform using a model to process a prompt;
in response to determining that the service has permission to access the knowledge box, searching the knowledge box to identify select contextual data relevant to the computer implemented task;
augmenting the prompt with the select contextual data for processing by the model to generate an output for the prompt; and
performing the computer implemented task based upon the output from the model.

11. The system of claim 10, wherein the operations further comprise:
identifying a set of skills available for the service for performing the computer implemented task; and
generating and providing an explanation of the set of skills to the service.

12. The system of claim 11, wherein the operations further comprise:
in response to the service invoking a skill of the set of skills, providing additional context for information provided by the skill, wherein the additional context is determined from the contextual data within the knowledge box.

13. The system of claim 10, wherein the operations further comprise:
selecting first contextual data as the select contextual data based upon the computer implemented task relating to a read workflow; and
selecting second contextual data as the select contextual data based upon the computer implemented task relating to a write workflow.

14. The system of claim 10, wherein the operations further comprise:
formatting the select contextual data based upon a type of question of the prompt and an amount of structure of the select contextual data to create formatted contextual data input into a large language model of the service.

15. The system of claim 10, wherein the operations further comprise:
storing contextual data of knowledge boxes within a vector database of a retrieval-augmented generation platform, wherein organizational contextual units of the knowledge boxes are tagged based upon search themes and queries;
selecting a contextual chunking strategy based upon a contextual use case of the computer implemented task; and
searching, based upon the prompt and a query deriving from the contextual chunking strategy, an organizational contextual unit of the knowledge box to identify the select contextual data, wherein the search is constrained to a subset of the vector database corresponding to the organizational contextual unit.

16. The system of claim 10, wherein the operations further comprise:
receiving, through an interface provided by a centralized contextual layer, a designation of one or more content items to upload into one or more knowledge boxes hosted by a vector database;
ingesting the one or more content items into the one or more knowledge boxes;
implementing a contextual chunking strategy for the one or more content items to create contextual chunks of organizational contextual units;
ranking the contextual chunks; and
providing a contextual chunk as the select contextual data to a large language model of the service.

17. A non-transitory computer-readable medium storing instructions that when executed by one or more processors facilitate performance of operations comprising:
creating a knowledge box to organize contextual data provided by knowledge sources paired with the knowledge box;
identifying a service that has been assigned a computer implemented task to perform using a model to process a prompt;
in response to determining that the service has permission to access the knowledge box, searching the knowledge box to identify select contextual data relevant to the computer implemented task;
augmenting the prompt with the select contextual data for processing by the model to generate an output for the prompt; and
performing the computer implemented task based upon the output from the model.

18. The non-transitory computer-readable medium of claim 17, wherein the operations further comprise:
in response to an agent orchestrator receiving the prompt, creating and queuing a job; and
processing, by an orchestrator worker, the job by:
selecting an agent definition corresponding to a select model for solving the computer implemented task specified by the job;
searching a skill library for a skill relevant to the computer implemented task based upon a knowledge map specifying skills available for the orchestrator worker for solving the computer implemented task;
providing the service with access to the skill;
augmenting a skill output from the skill with additional context obtained from the knowledge box to create an augmented output; and
generating the output for the computer implemented task based upon the augmented output.

19. The non-transitory computer-readable medium of claim 17, wherein the operations further comprise:
determining a structure type of available contextual data;
determining a specificity type of a query of the prompt; and
selecting a contextual content source for obtaining the select contextual data based upon the structure type and the specificity type, wherein the contextual content source is selected from a set of contextual content sources including a retrieval-augmented generation platform, an application programming interface (API) endpoint, a natural language processing API endpoint, or a structured tag library.

20. The non-transitory computer-readable medium of claim 17, wherein the operations further comprise:
in response to detecting a user correction for the output, training a centralized contextual layer hosting the knowledge box for subsequently selecting contextual data.
